(19) United States
(12) Patent Application Publication
(10) Pub. No.: US 2010/0110950 A1
(43) Pub. Date: May 6, 2010

(54) METHOD AND APPARATUS FOR ALIGNING POWER SAVINGS CLASSES

(75) Inventors: Mamadou Kone, Jhudong Township (TW); Yu-Min Chiu, Hsinchu City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute.

(21) Appl. No.: 12/265,163

(22) Filed: Nov. 5, 2008

(51) Int. Cl. G08C 17/00

(52) U.S. Cl. 370/311

(57) ABSTRACT

A method for power savings in a wireless communications network, including selecting all Type-1 power savings classes (PSCs), selecting all Type-2 PSCs, and selecting all Type-3 PSCs. The method further includes aligning the Type-1 PSCs of the device, if more than one Type-1 PSC is selected, and aligning the Type-2 PSCs of the device, if more than one Type-2 PSC is selected. The method also includes aligning the two or more aligned Type-1 PSCs or, if only one Type-1 PSC is selected, the Type-1 PSC, and the two or more aligned Type-2 PSCs or, if only one Type-2 PSC is selected, the Type-2 PSC, if there is at least one Type-1 PSC and at least one Type-2 PSC. The method may further include aligning the Type-3 PSCs with the aligned Type-1 and Type-2 PSCs, if there is at least one Type-3 PSC and at least one Type-1 or Type-2 PSC.

### TECHNICAL FIELD

The present disclosure relates generally to methods and devices for wireless communication systems and, more particularly, to methods and devices for wireless communication systems to provide power savings.

### BACKGROUND

Due to an increasing number of wireless devices and a growing demand for wireless services, wireless communication systems continue to expand. To meet the growing demand, and to increase interoperability and reduce costs, various sets of standards have been introduced for wireless communications. One such set of standards developed for wireless communication is Institute of Electrical and Electronics Engineers, Inc. (IEEE) 802.16. IEEE 802.16 includes the family of standards developed by the IEEE 802.16 committee, establishing standards for broadband wireless access. In part, the IEEE 802.16 family of standards defines interoperability of broadband Wireless Metropolitan Area Networks (WirelessMAN). Generally speaking, WirelessMANs are large networks utilizing wireless infrastructure to form connections between subscriber stations. Wi-Max, a term defined and promoted by The Wi-Max Forum™, is commonly used to refer to WirelessMANs and wireless communication and communication networks that are based on the IEEE 802.16 standard. As used herein, the term “Wi-Max” refers to any communication network, system, apparatus, device, method, etc. that utilizes or is based on the 802.16 family of standards. Included in the 802.16 family of standards is the IEEE 802.16e standard, which relates to mobile Wi-Max. The IEEE 802.16e standard proposes grouping connections according to their Quality of Service types to create Power Saving Classes (PSC). Each type of PSC has a set of message exchange procedures for its definition/activation/deactivation. Moreover, IEEE 802.16e defines a general set of parameters and rules that can be used to design different sleep and listening windows. IEEE 802.16 enumerates three kinds of PSCs:
Type I Power Saving Class (Type 1 PSC): Groups together BE and NRT-VR connections. A fixed length listening window alternates with a sleep window, where each sleep window is twice the size of a previous sleep window, to some maximum sleep window size.
Type II Power Saving Class (Type 2 PSC): Groups together UGS, ERT-VR, and RT-VR connections. A fixed length listening window alternates with a fixed length sleep window.

Type III Power Saving Class (Type 3 PSC): Groups together multicast connections and management connections. A single sleep window whose duration is based on an expected time period before activity. The duration and separation of the expected time period of activity and the sleep window, i.e., the expected time period before activity is set based on an expected arrival of a next portion of data or next expected ranging request.

In addition, IEEE 802.16e supports a device mode. A device mode provides energy savings on a mobile station when the traffic load is low. A device mode consists of alternating unavailability intervals and availability intervals. Generally, during the unavailability interval the device cuts off all contact with its serving base station and conserves its energy. During the availability interval, the device actively waits for traffic and/or sends packets out. The unavailability interval is defined in IEEE 802.16e as a time interval that does not overlap with any listening window of any active PSC. The availability interval is defined in IEEE 802.16e as a time interval that does not overlap with any unavailability interval.

IEEE 802.16e defines the relationship between unavailability intervals and availability intervals.

The disclosed embodiments are directed to overcoming one or more of the problems set forth above.

### SUMMARY

In one exemplary embodiment, the present disclosure is directed to a method for power savings in a wireless communications network, comprising: selecting all Type 1 power savings classes (PSCs), if present on a device; selecting all Type 2 PSCs, if present on the device; selecting all Type 3 PSCs, if present on the device; aligning the selected Type 1 PSCs of the device, if more than one Type 1 PSC is selected; aligning the selected Type 2 PSCs of the device, if more than one Type 2 PSC is selected; aligning the two or more aligned Type 1 PSCs or, if only one Type 1 PSC is selected, the selected Type 1 PSC, and the two or more aligned Type 2 PSCs or, if only one Type 2 PSC is selected, the selected Type 2 PSC, if there is at least one selected Type 1 PSC and at least one selected Type 2 PSC; and aligning the selected Type 3 PSCs with the aligned Type 1 and Type 2 PSCs, if there is at least one selected Type 3 PSC and at least one Type 1 or Type 2 PSC.

In another exemplary embodiment, the present disclosure is directed to a wireless communication mobile station for wireless communication, comprising: at least one memory to store data and instructions; and at least one processor configured to access the memory and execute instructions. The processor is configured to, when executing the instructions: select all Type 1 power savings classes, if present on a device; select all Type 2 power savings classes, if present on the device; select all Type 3 power savings classes, if present on the device; align the selected Type 1 power savings classes of the device, if more than one Type 1 power savings class is selected; align the selected Type 2 power savings classes of the device, if more than one Type 2 power savings class is selected; align the two or more aligned Type 1 power savings classes or, if only one Type 1 power savings class is selected, the selected Type 1 power savings class, and the two or more aligned Type 2 power savings classes or, if only one Type 2 power savings class is selected, the selected Type 2 power savings class, if there is at least one selected Type 1 power savings class and at least one selected Type 2 power savings class; and align the selected Type 3 power savings classes with the aligned Type 1 and Type 2 power savings classes, if there is at least one selected Type 3 power savings class and at least one Type 1 or Type 2 power savings class.

In a further exemplary embodiment, the present disclosure is directed to a computer-readable medium including instructions for performing a method, when executed by a processor, for power savings in a wireless communications network, the method comprising: selecting all Type 1 power savings classes, if present on a device, wherein each of the one or more Type 1 power savings classes has a series of equal fixed duration listening windows alternating with a series of sleep windows, and wherein each sleep window has twice a duration of a previous sleep window, up to a maximum sleep window duration, and an initial sleep window duration is greater than or equal to the listening window fixed duration; selecting all Type 2 power savings classes, if present on the device, wherein each of the one or more Type 2 power savings classes has a series of equal fixed duration listening windows alternating with a series of equal fixed duration sleep windows and the sleep window duration is greater than the listening window duration; selecting all Type 3 power savings classes, if present on the device, wherein each of the one or more Type 3 power savings classes has a sleep window wherein durations and separations of an expected time period of activity and the sleep window is set based on an expected arrival of a next portion of data or next expected ranging request; aligning the selected Type 1 power savings classes of the device, if more than one Type 1 power savings class is selected; aligning the selected Type 2 power savings classes of the device, if more than one Type 2 power savings class is selected; aligning the two or more aligned Type 1 power savings classes or, if only one Type 1 power savings class is selected, the selected Type 1 power savings class, and the two or more aligned Type 2 power savings classes or, if only one Type 2 power savings class is selected, the selected Type 2 power savings class, if there is at least one selected Type 1 power savings class and at least one selected Type 2 power savings class; aligning the selected Type 3 power savings classes with the aligned Type 1 and Type 2 power savings classes, if there is at least one selected Type 3 power savings class and at least one Type 1 or Type 2 power savings class; and communicating the alignment of any Type 1, Type 2, or Type 3 power savings classes to a base station.

### BRIEF DESCRIPTION OF THE DRAWINGS

FIG. 1 is a block diagram of an exemplary Wi-Max network;

FIG. 2a is a block diagram of an exemplary Base Station, consistent with certain disclosed embodiments;

FIG. 2b is a block diagram of an exemplary Stationary Station, consistent with certain disclosed embodiments;

FIG. 2c is a block diagram of an exemplary Mobile Station, consistent with certain disclosed embodiments;

FIG. 3 is a flow chart illustrating an exemplary power saving mode request consistent with certain disclosed embodiments;

FIG. 4a is an exemplary diagram including a horizontal time axis, illustrating availability and unavailability intervals of a mobile device based on sleep and listening windows of multiple unaligned PSCs, consistent with certain disclosed embodiments;

FIG. 4b is an exemplary diagram including a horizontal time axis, illustrating availability and unavailability intervals of a mobile device based on sleep and listening windows of multiple aligned PSCs, consistent with certain disclosed embodiments;

FIG. 5 is an exemplary diagram including a horizontal time axis, illustrating availability and unavailability intervals of a mobile device based on sleep and listening windows of two unaligned Type 2 PSCs, consistent with certain disclosed embodiments;

FIG. 6 is an exemplary diagram including a horizontal time axis, illustrating availability and unavailability intervals of a mobile device based on sleep and listening windows of two Type 2 PSCs and one Type 1 PSC that are aligned by sleep window start times, consistent with certain disclosed embodiments;

FIG. 7 is an exemplary diagram including a horizontal time axis, illustrating availability and unavailability intervals of a mobile device based on sleep and listening windows of two Type 2 PSCs and one Type 1 PSC that are aligned to place longer unavailability intervals at the start of a cycle, consistent with certain disclosed embodiments;

FIG. 8 is a flow chart illustrating an exemplary method to align three or more Type 2 PSCs, consistent with certain disclosed embodiments;

FIG. 9a is an exemplary diagram including a horizontal time axis, illustrating availability and unavailability intervals of a mobile device based on sleep and listening windows of five Type 1 PSCs that are aligned by initial sleep window start time, consistent with certain disclosed embodiments;

FIG. 9b is an exemplary diagram including a horizontal time axis, illustrating availability and unavailability intervals of a mobile device based on sleep and listening windows of five Type 1 PSCs that are aligned, consistent with certain disclosed embodiments;

FIG. 10 is a flow chart illustrating an exemplary method to align three or more Type 1 PSCs, consistent with certain disclosed embodiments;

FIG. 11 is an exemplary diagram including a horizontal time axis, illustrating availability and unavailability intervals of a mobile device based on sleep and listening windows of multiple PSCs with different PSC Types that are aligned, consistent with certain disclosed embodiments;

FIG. 12 is a flow chart illustrating an exemplary method to align multiple PSCs with different PSC Types, consistent with certain disclosed embodiments;

FIG. 13 is an exemplary diagram including a horizontal time axis, illustrating available and unavailable intervals of a mobile device based on sleep and listening windows of multiple PSCs where the initial sleep window of a Type 1 PSC is greater than the sleep window of a Type 2 PSC and the listening window of the Type 1 PSC is greater than the listening window of the Type 2 PSC, consistent with certain disclosed embodiments;

FIG. 14 is an exemplary diagram including a horizontal time axis, illustrating available and unavailable intervals of a mobile device based on sleep and listening windows of multiple PSCs where the sleep window of a Type 2 PSC is greater than the initial sleep window of a Type 1 PSC and the listening window of the Type 2 PSC is greater than the listening window of the Type 1 PSC, consistent with certain disclosed embodiments;

FIG. 15 is an exemplary diagram including a horizontal time axis, illustrating available and unavailable intervals of a mobile device based on sleep and listening windows of multiple PSCs where the sleep window of a Type 2 PSC is greater than or equal to the initial sleep window of a Type 1 PSC and the listening window of the Type 1 PSC is greater than the listening window of the Type 2 PSC, consistent with certain disclosed embodiments;

FIG. 16 is an exemplary diagram including a horizontal time axis, illustrating available and unavailable intervals of a mobile device based on sleep and listening windows of multiple PSCs where the sleep window of a Type 2 PSC is greater than or equal to the initial sleep window of a Type 1 PSC and the listening window of the Type 1 PSC is equal to the listening window of the Type 2 PSC, consistent with certain disclosed embodiments;

FIG. 17 is an exemplary diagram including a horizontal time axis, illustrating available and unavailable intervals of a mobile device based on sleep and listening windows of multiple PSCs where the initial sleep window of a Type 1 PSC is greater than or equal to the sleep window of a Type 2 PSC and the listening window of the Type 2 PSC is greater than the listening window of the Type 1 PSC, consistent with certain disclosed embodiments; and

FIG. 18 is an exemplary diagram including a horizontal time axis, illustrating available and unavailable intervals of a mobile device based on sleep and listening windows of multiple PSCs where the initial sleep window of a Type 1 PSC is greater than the sleep window of a Type 2 PSC and the listening window of the Type 2 PSC is equal to the listening window of the Type 1 PSC.

### DETAILED DESCRIPTION

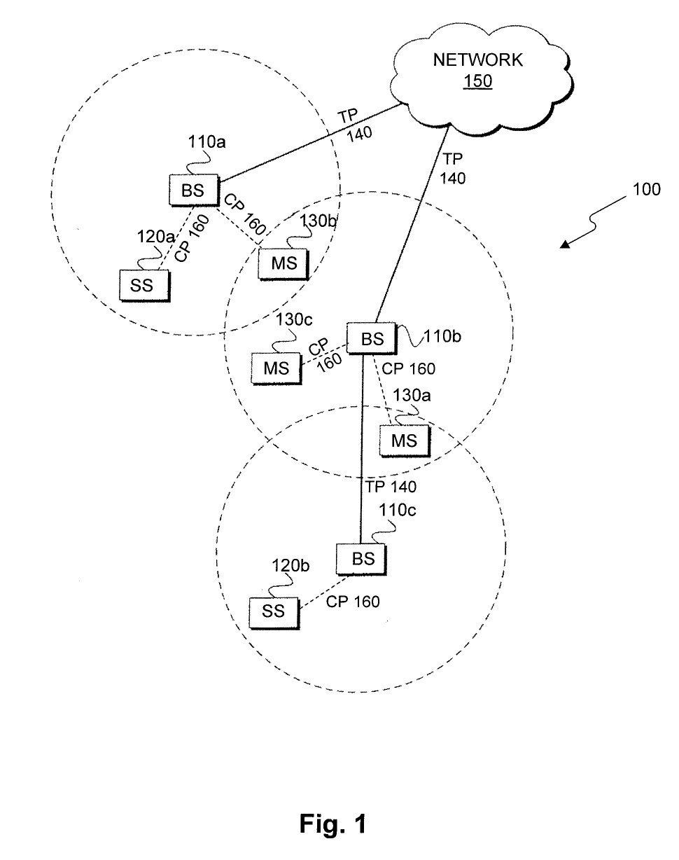

FIG. 1 is a block diagram of an exemplary Wi-Max network 100 based on the IEEE 802.16 family of standards, consistent with certain disclosed embodiments. As shown in FIG. 1, Wi-Max network 100 may include one or more transmitters, e.g., base stations (BS) 110, including BSs 110a, 110b, and 110c, one or more receivers, e.g., stationary stations (SS) 120, including SSs 120a and 120b, and mobile stations (MS) 130, including MSs 130a, 130b, and 130c. While the discussion of FIG. 1 will be made with reference to the IEEE 802.16 family of standards, it is to be understood that the systems and methods disclosed herein may be used in any type of network having a plurality of nodes and remote communication stations.

The one or more BSs 110 may include any type of communication device configured to transmit and/or receive communications based on the IEEE 802.16 family of standards, many of which are known in the art. In one exemplary embodiment, the one or more BSs 110 are connected by transmission paths 140 (TP) to a network 150. In addition, BSs 110 may be configured to communicate with one or more SSs 120, MSs 130, and/or other BSs 110 using communication protocols on communication path 160s (CP) also defined by the 802.16 family of standards. In one exemplary embodiment, BSs 110 serves as an intermediary between one or more SSs 120, MSs 130, or BSs 110 and network 150. Communication with network 150 may be made via wired connections, wireless connections, or any combination thereof. Network 150 can include, for example, any combination of one or more WANs, LANs, intranets, extranets, Internet, etc.

SSs 120 and MSs 130 may include any type of wireless client device configured to communicate with BS 110 and/or other SSs 120 and MSs 130 using the communication protocols on CP 160 defined by the 802.16 family of standards. Each SS 120 and MS 130 may include, for example, servers, clients, mainframes, desktop computers, laptop computers, network computers, workstations, personal digital assistants (PDA), tablet PCs, scanners, telephony devices, pagers, cameras, musical devices, etc. In one exemplary embodiment, SS 120 is a Wi-Fi device enabled to communicate with BS 110 using the communication protocols on CP 160 defined by the 802.16 family of standards. Each BS 110 has a broadcast range within which that BS 110 can communicate with SS 120, MS 130, and one or more other BSs 110. Broadcast ranges of each BS 110 may vary due to power levels, location, interference (physical and/or electromagnetic), etc. Similarly, each SS 120 and MS 130 has a broadcast range within which that SS 120 and MS 130 may communicate with one or more other SSs 120, MSs 130 and/or BSs 110. Broadcast ranges of each SS 120 and MS 130 may vary due to power levels, location, interference (physical and/or electromagnetic), etc. In addition to the ability of each BS 110 to connect and communicate with SS 120 and MS 130, each BS 110 may also connect and communicate with one or more other BSs 110 using a line-of-sight, wireless link using the protocols and standards defined by the IEEE 802.16 family of standards.

TP 140 is a transmission path that may include one or more nodes in network 100. TP 140 may be wired, wireless, or any combination of wired and/or wireless communication means and/or methods.

Still referring to FIG. 1, BS 110 may be configured to create and store one or more data structures associated with one or more SSs 120, MSs 130, TPs 140, and/or one or more CPs 160, as well as to create and store one or more relationships between the data structures. For example, BS 110 may store one or more subscriber or mobile station identifiers, one or more transmission path identifiers, one or more communication path data structures, one or more transmission path data structures, etc.

In addition, MS 130 may be configured to create and store one or more data structures associated with one or more BSs 110, SSs 120, MSs 130, TPs 140, and/or one or more CPs 160, as well as to create and store one or more relationships between the data structures. For example, MS 130 may store data on one or more of: all known connections, the period of threshold communication activity, power savings classes, one or more subscriber or mobile station identifiers, one or more transmission path identifiers, one or more communication path data structures, one or more transmission path data structures, etc.

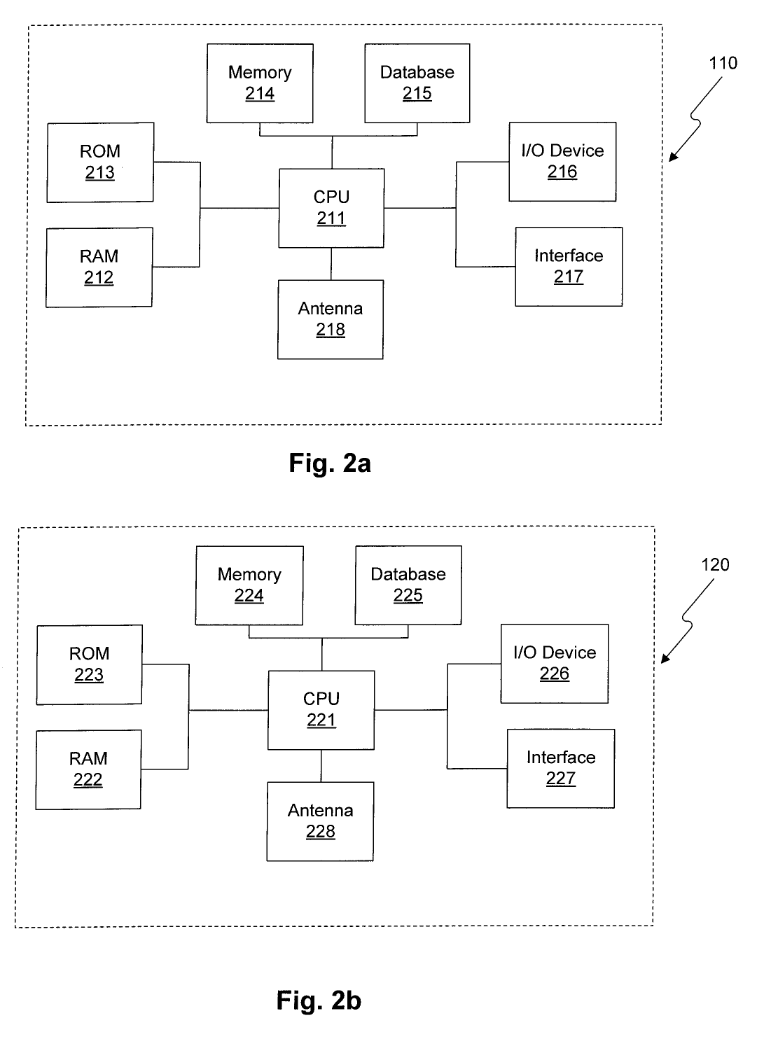

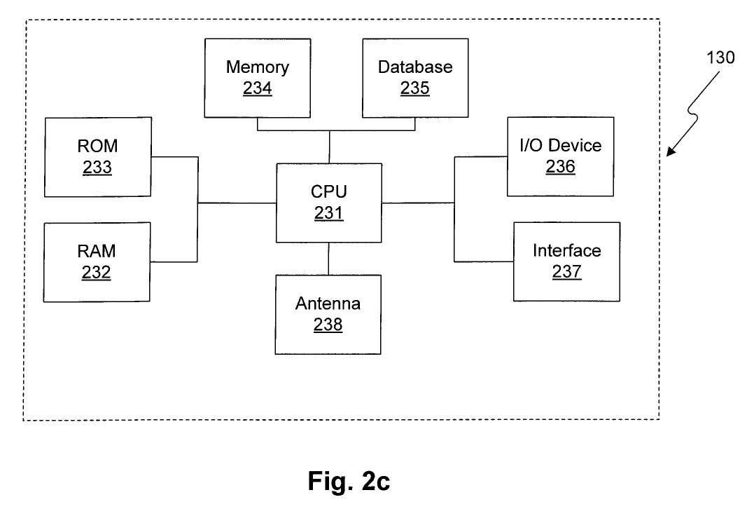

FIG. 2a is a block diagram of an exemplary structure of BS 110. As shown in FIG. 2a, BS 110 may include one or more of the following components: at least one central processing unit (CPU) 211 configured to execute computer program instructions to perform various processes and methods, random access memory (RAM) 212 and read only memory (ROM) 213 configured to access and store information and computer program instructions, memory 214 to store data and information, one or more databases 215 to store tables, lists, or other data structures, one or more input/output (I/O) devices 216, one or more interfaces 217, one or more antennas 218, etc. Each of these components is well-known in the art and will not be discussed further.

FIG. 2b is a block diagram of an exemplary structure of SS 120. As shown in FIG. 2b, SS 120 may include one or more of the following components: at least one CPU 221 configured to execute computer program instructions to perform various processes and methods, RAM 222 and ROM 223 configured to access and store information and computer program instructions, memory 224 to store data and information, one or more databases 225 to store tables, lists, or other data structures, one or more I/O devices 226, one or more interfaces 227, one or more antennas 228, etc. Each of these components is well-known in the art and will not be discussed further.

SS 120 may include any type of wireless client device configured to communicate with BSs 110, other SSs 120, and/or MSs 130 using one or more wireless communication standards including, for example, the IEEE 802.16 family of standards. SSs 120 may include, for example, servers, clients, mainframes, desktop computers, laptop computers, network computers, workstations, tablet PCs, scanners, telephony devices, pagers, cameras, musical devices, etc. The location of SS 120 is stationary and SS 120 is expected to remain in contact with the same group of BSs 110 and SSs 120.

FIG. 2c is a block diagram of an exemplary structure of MS 130. As shown in FIG. 2c, MS 130 may include one or more of the following components: at least one CPU 231 configured to execute computer program instructions to perform various processes and methods, RAM 232 and ROM 233 configured to access and store information and computer program instructions, memory 234 to store data and information, one or more databases 235 to store tables, lists, or other data structures, one or more I/O devices 236, one or more interfaces 237, one or more antennas 238, etc. Each of these components is well-known in the art and will not be discussed further.

MS 130 may include any type of wireless client device configured to communicate with BSs 110, SSs 120, and/or other MSs 130 using one or more wireless communication standards including, for example, the IEEE 802.16 family of standards. MSs 130 may include, for example, servers, clients, mainframes, desktop computers, laptop computers, network computers, workstations, personal digital assistants (PDA), tablet PCs, scanners, telephony devices, pagers, cameras, musical devices, etc. In one exemplary embodiment, MS 130 is a mobile computing device. In other embodiments, MS 130 is a “non-mobile” computing device located in a mobile environment (e.g., airplanes, watercraft, buses, multi-passenger vehicles, automobiles, etc.).

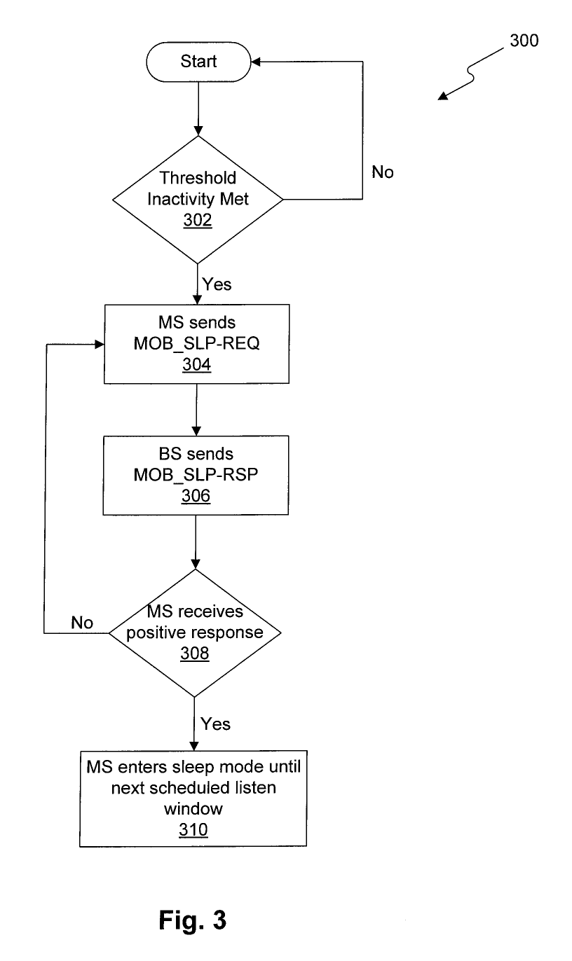

FIG. 3 is a flow chart 300 of an exemplary power saving mode request consistent with IEEE 802.16e. In step 302, MS 130 monitors a threshold communications inactivity period and determines if a prerequisite period of threshold communication inactivity has been met. If the prerequisite period of threshold communication inactivity has not been met, MS 130 waits for a duration, then checks step 302 again. In step 304, after the prerequisite period of threshold communication inactivity has exceeded its threshold, MS 130 sends a mobile station sleep request MOB_SLP-REQ to BS 110 to negotiate a sleep window. The MOB_SLP-REQ contains information from MS 130 necessary to implement power savings. In step 306, BS 110 responds with a mobile station sleep response MOB_SLP-RSP including its response to the request to negotiate a sleep window from MS 130. In step 308, MS 130 determines if the response to its sleep window request was proper and positive. If the response was not proper and positive, MS 130 repeats step 304. If the response was proper and positive, in step 310 MS 130 enters a power savings mode at an appropriate time in accordance with the received sleep response.

In one exemplary embodiment, a power savings mode may include alternating sleep windows and listening windows. During the sleep window, MS 130 cuts off all contact with its serving BS 110 and conserves its power, or uses its power for other tasks. During the listening window, MS 130 actively waits for traffic and/or sends out packets.

The power saving mode has several PSCs. In one exemplary embodiment, the above noted three PSCs of IEEE 802.16e are configured as follows. In a Type 1 PSC, sleep windows increase in size at each sleep window by doubling the previous sleep window until a determined maximum sleep window size is reached at which the sleep window size remains unchanged. The listening window may be maintained at a fixed duration. A Type 2 PSC has sleep and listening windows of fixed duration. Type 2 PSCs are composed primarily of UGS, ERT-VR, and RT-VR connections. A Type 3 PSC has its sleep window duration set based on the expected arrival of the next portion of data or next expected ranging request. Periodically a ranging request may be used to determine the distance between a MS 130 and any BS 110 within range of MS 130. Ranging and range requests are well known in the art and will not be further discussed.

PSC listening windows, sleep windows, availability intervals, and unavailability intervals, each have a duration, which is a measurement in time. In one exemplary embodiment, the measurement in time is a frame. A frame in one exemplary embodiment may have a duration between 2 milliseconds and 20 milliseconds. In other exemplary embodiments, a frame may be a shorter or a longer duration. As used below, length, when referring to a PSC listening window, sleep window, availability interval, and unavailability interval, is referring to the duration in time, not to a physical measurement of distance.

A plurality of PSCs are formed from selecting connections with common performance characteristics. Quality of Service (QoS) types can be used to sort connections into PSCs with similar performance characteristics. After selecting connections with common performance characteristics to create a plurality of PSCs respectively composed of connections with similar characteristics, a power savings window size is determined for each PSC. The determination of power savings window size includes determining the sizes of listening windows and sleep windows. Desirably, the power savings window sizes are determined to decrease power consumption and maintain QoS performance levels.

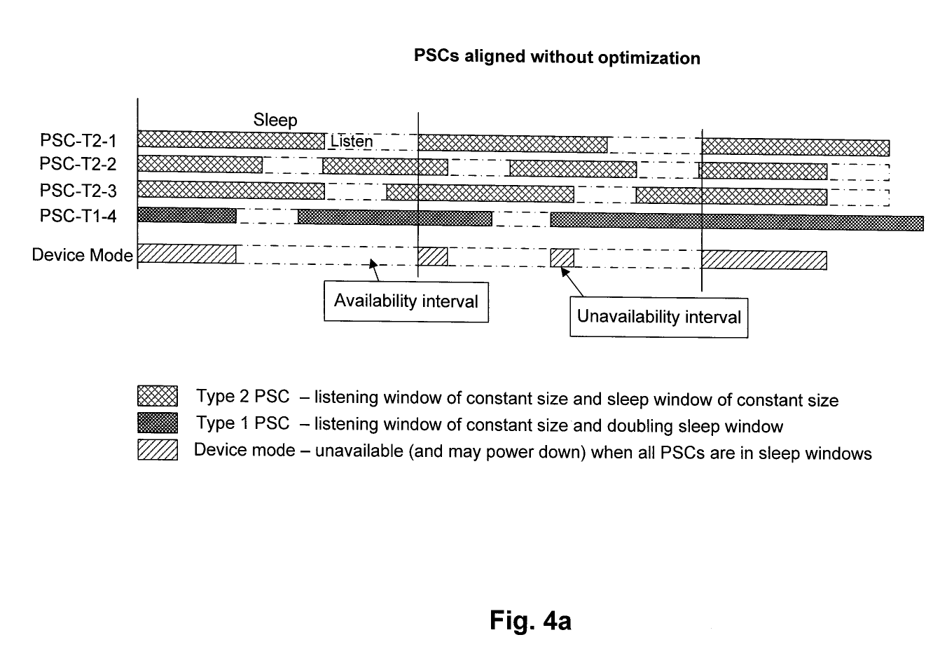

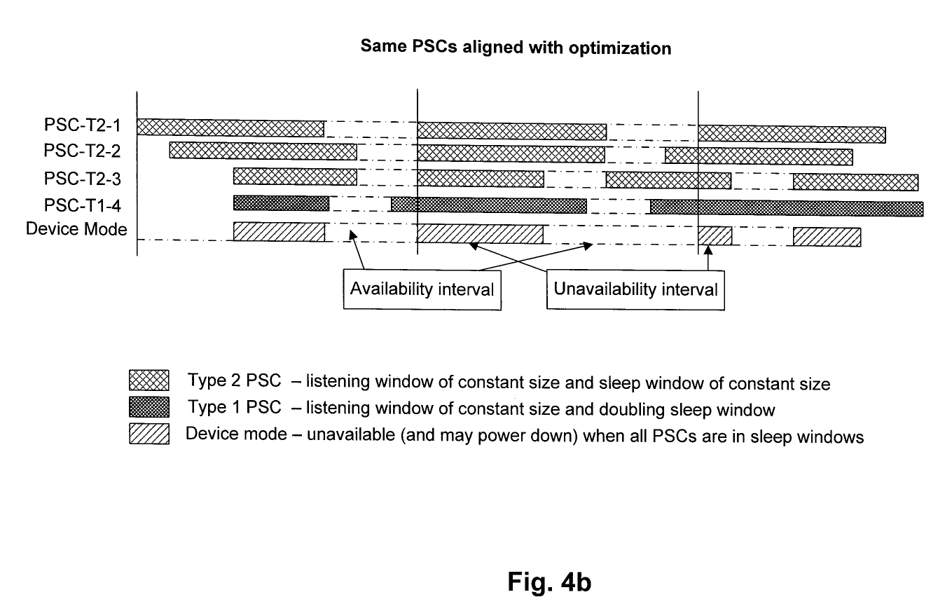

FIG. 4a is an exemplary diagram including a horizontal time axis, illustrating availability and unavailability intervals of a mobile device, e.g., MS 130, based on sleep and listening windows of multiple PSCs. More particularly, FIG. 4a shows an exemplary embodiment of alignment in which all of the PSCs with the same start time are aligned. PSC-T2-1 (Power Savings Class-Type 2-1) may have alternating sleep and listening windows. Similarly, PSC-T2-2 and PSC-T2-3 may also have alternating sleep and listening windows. PSC-T2-1, PSC-T2-2, and PSC-T2-3 are all Type 2 PSCs, and PSC-T1-4 (Power Savings Class-Type 1-4) is a Type 1 PSC, and PSC-T1-4 may also have alternating sleep and listening windows.

As shown in FIG. 4a, MS 130 may have a device mode, as long as the PSCs are active, corresponding to the availability interval and unavailability interval. The device mode is set to unavailable when all of the PSCs' windows are set to sleep. When one or more of the PSCs are in a listening window, the device mode will be set to available.

FIG. 4b is an exemplary diagram including a horizontal time axis, illustrating availability and unavailability intervals of a mobile device, e.g., MS 130, based on sleep and listening windows of multiple PSCs. More particularly, FIG. 4b shows an exemplary embodiment of alignment. This example may be created by selecting the start time for each PSC to generate overlap of the sleep windows of the PSC and reduce long availability intervals on the device. The PSCs are the same in FIGS. 4a and 4b, but in FIG. 4b the unavailability intervals are longer and more evenly spaced.

Alignment of multiple PSCs can be accomplished in various ways. The following disclosure provides alignment for multiple Type 1 PSCs or multiple Type 2 PSCs, or a combination of multiple Type 1 PSCs and multiple Type 2 PSCs. Generally, the disclosed embodiments may first sort the PSCs based on type, i.e., sort into different groups of PSC types. Each group of PSC type is then sorted by order, i.e., by increasing or decreasing duration, followed by pair-by-pair alignment of the PSCs of a type. The order of the PSCs in a type and the pair-by-pair alignment is used to align all PSCs within a type. Last, the different aligned types of PSCs are aligned, creating an alignment for all the PSCs. If there are not enough PSCs for a particular step, that step will not be performed for that type of PSC.

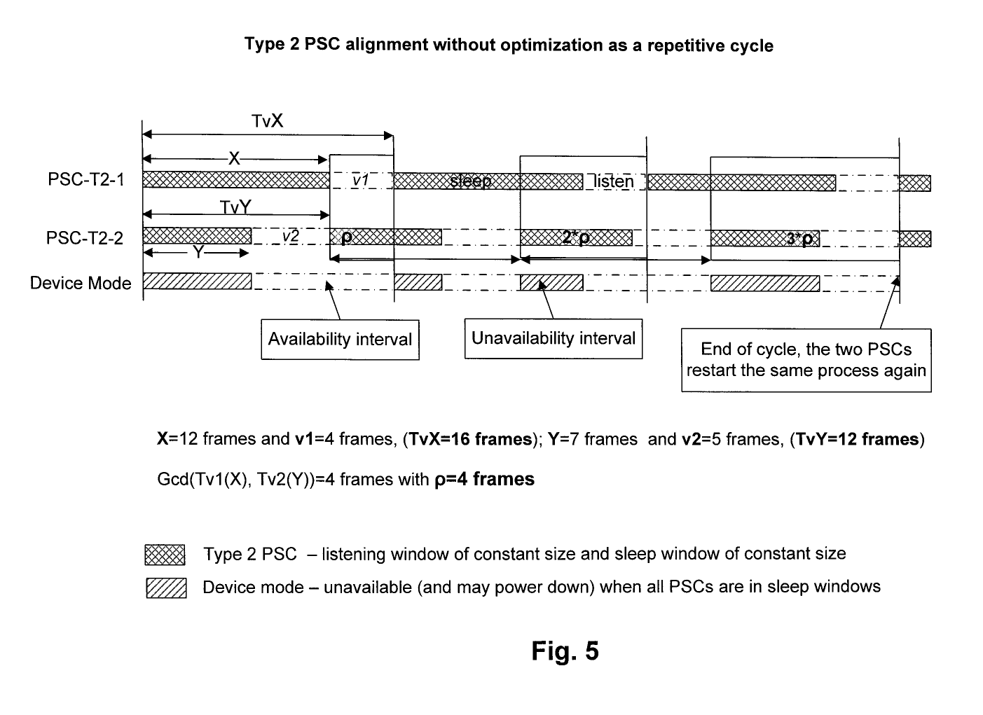

FIG. 5 is an exemplary diagram including a horizontal time axis, illustrating availability and unavailability intervals of a mobile device, e.g., MS 130, based on sleep and listening windows of two Type 2 PSCs, PSC-T2-1 and PSC-T2-2. More particularly, FIG. 5 shows an alignment as a repetitive cycle for PSC-T2-1 and PSC-T2-2. As discussed above, a Type 2 PSC has fixed length listening windows alternating with fixed length sleep windows. The listening window of a Type 2 PSC is shorter than the sleep window of the same Type 2 PSC. As shown in FIG. 5, for PSC-T2-1, the sleep window length is X and the listening window length is v1. v1 can be thought of as a vector, and Tv1 as a translation of v in the time domain, where Tv1(X)≡X+v1, the sleep and listening window of a Type 2 PSC. Further, a second or further Type 2 PSC, PSC-T2-2 can be represented by Tv2(Y)≡Y+v2, etc., where for PSC-T2-2 the sleep window length is Y and the listening window length is v2. It will be assumed that in all Type 2 PSCs the listening windows (v1, v2, etc.) are smaller then the smallest sleep window, such as Y. In other words, not only is v1<X, v2<Y, but, v1, v2, etc. <smallest of (X, Y, etc.).

The difference in length of two Type 2 PSC, such as PSC-T2-1 and PSC-T2-2, can be expressed as ρ, where ρ=Tv1(X)−Tv2(Y). There is some number r, where r*ρ=W=Tv2(Y) and it then follows that there must be some n and some m such that m*Tv1(X)=n*Tv2(Y). The greatest common divisor (Gcd) of Tv1(X) and Tv2(Y) can generate m and n such that m*Tv1(X)=n*Tv2(Y). If Gcd(Tv1(X), Tv2(Y))=z, where z is a positive integer, then Ntx=Tv2(Y)/z, Nty=Tv1(X)/z, and Ntx*Tv1(X)=Nty*Tv2(Y). Ntx and Nty are the number of translations of X and Y to have the distance Ntx*Tv1(X)=Nty*Tv2(Y).

If Tv1(X) is a multiple of Tv2(Y), then z=Tv2(Y). In other words, the Gcd(Tv1(X), Tv2(Y))=Tv2(Y). An example might be Gcd(9, 3)=3. Further, if z=1, Ntx=Tv2(Y) and Nty=Tv1(x). In other words, Tv1(X)*Tv2(Y)=Tv1(X)*Tv2(Y). Thus, for example, if Gcd(9, 7)=1, Ntx=Tv2(Y)/z=7/1, Nty=Tv1(X)/z=9/1, and Ntx*Tv1(X)=Nty*Tv2(Y)==7*9=9*7=63.

Cycle=Ntx*Tv1(X)=Nty*Tv2(Y), Eq. 1
wherein:
   Ntx is the number of translations of X to equal Nty*Tv2(Y)
   Tv1(X) is the duration of a Type 2 PSC X
   Nty is the number of translations of Y to equal Ntx*Tv1(X)
   Tv2(Y) is the duration of a Type 2 PSC Y

The cycle defined by equation (1) is the number of translations needed before two different metric spaces (PSCs) repeat their relationship with respect to each other. In other words, a cycle is the duration before two PSCs repeat the same spatial relationship with respect to each other. Thus, a set of instructions that produces a result in a cycle for two Type 2 PSCs will produce the same result in every other cycle of the same two Type 2 PSCs. A round is every translation of X which equals Tv1(X). In other words, a cycle is composed of Ntx rounds of Tv1(X) and Nty rounds of Tv2(Y).

For Type 2 PSCs, a set of rules and equations provides a basis for analyzing the possible alignments of a pair of Type 2 PSCs:

Tv1(X)>Tv2(Y), Eq. 2

If Uₒ≧Tv2(Y), then set Uₒ=Uₒ−Tv2(Y) Eq. 3

If Uₒ+Y>X, then set A=X−Uₒ and v2=v2+(Uₒ+Y)−X Eq. 4

Alignment of (Tv1(X), Tv2(Y))=(U₁+U₂)+(U₃+U₄)+ . . . +(Uₙ₋₁+Uₙ) Eq. 5

U₁=(Y+Uₒ)+v2 and U₂=U₁−(X+v1) Eq. 6

U₃=(Y+U₂)+v2 and U₄=U₃−(X+v1) Eq. 7

(U₁+U₂)₁+(U₃+U₄)₂+ . . . +(Uₙ₋₁+Uₙ)_{Ntx} rounds with n terms, for n=2*Ntx Eq. 8

If (X−U₁)>Y, then set B=Y and v1=v1+((X−U₁)−Y) Eq. 9

If (Y+Uₒ)>=Y, then set A=Y Eq. 10

For (A,B), A=(Y+Uₙ₋₂), B=(X−Uₙ₋₁), A>0, B>0 if A<0, A=0 and if B<0, B=0 with n=2*Ntx Eq. 11
wherein:

TABLE 1
Definitions of Variables for Eq. 2 to Eq. 12

| | |
|---|---|
| Tv1(X) | Duration of a Type 2 PSC X |
| Tv2(Y) | Duration of a Type 2 PSC Y |
| U_{O} | Difference between the start time of Tv1(X) and Tv2(Y) |
| X | Sleep window of Tv1(X) |
| Y | Sleep window of Tv2(Y) |
| v1 | Listening window of Tv1(X) |
| v2 | Listening window of Tv2(Y) |
| Ntx | Number of translations of X to equal Nty * Tv2(Y) |
| Nty | Number of translations of Y to equal Ntx * Tv1(X) |
| U₁ | Difference between the start time of Tv1(X) and 2 * Tv2(Y) |
| U₂ | Difference between the start time of 2 * Tv1(X) and 2 * Tv2(Y) |
| U₃ | Difference between the start time of 2 * Tv1(X) and 3 * Tv2(Y) |
| U₄ | Difference between the start time of 3 * Tv1(X) and 3 * Tv2(Y) |
| Uₙ₋₁ | Difference between the start time of (Ntx) * Tv1(X) and |
| | (Ntx + 1) * Tv2(Y) |
| Uₙ | Difference between the start time of (Ntx + 1) * Tv1(X) and |
| | (Ntx + 1) * Tv2(Y) |
| A | First possible unavailability interval for a round |
| B | Second possible unavailability interval for a round |

Uo is the difference between the start time of Tv1(X) and Tv2(Y). Uo=0 when Tv1(X) and Tv2(Y) have the same start time.

Eq. 2 is the condition that the duration of Tv1(X) must be greater than the duration of Tv2(Y). Thus, one of the Type 2 PSCs must be longer then the other, and for consistency herein, the Type 2 PSC with the longer duration will be called Tv1 (X).

In Eq. 3, when Uo is greater than or equal to the duration of the shorter Type 2 PSC, Tv2(Y), the duration of Tv2(Y) is subtracted from Uo. For Type 2 PSCs, it is desirable that the shorter Type 2 PSC, e.g., Tv2(Y), starts within its own length of the start time of the longer Type 2 PSC, i.e., Tv1(X). After the first cycle, the next cycle will be a mirror image of the first cycle, except that Tv2(Y) will have its first start of the cycle within its own length of the start time of Tv1(X).

In Eq. 4, when the sum of the initial delay Uo and Y, the sleep window of Tv2(Y), is greater than X, the duration of the sleep window of Tv1(X), the listening window of Tv2(Y) is increased by the difference between the sum of the initial delay Uo and the sleep window of Tv2(Y) and the duration of the sleep window of Tv1(X). The listening window of Tv1(X) may overlap with a sleep window of Tv2(Y), and the overlap is added to v2. In this case, the unavailability interval A corresponds to the length of the sleep window of Tv1(X) minus the length of Uo.

Eq. 5, 6, and 7 show how to align Tv1(X) and Tv2(Y). First, Uo is selected. Since for two Type 2 PSCs, the sleep windows X and Y are known, as are the listening windows v1 and v2, using Eq. 6 and Eq. 7, all Un for a cycle are calculated. For each U calculated, the conditions of Eq. 3, Eq. 4, Eq. 9, and Eq. 10 are considered, and applied if appropriate. Eq. 5 is presented as a pair of U's for each round. Each pair of Us may be further broken into the unavailability intervals Y+Un−2 and X−Un−1 and the availability intervals v2 or v1. The unavailability intervals Y+Un−2 and X−Un−1 correspond to A and B in Eq. 11 with n=2*Ntx. Because of the positive sign of Uo in the formulas, Un−1=Y+Un−2+v2 and Un=Un−1−(X+v1) are used only to calculate the U's of the next round, as in Eq. 6, Eq. 7, and Eq. 8, and not to calculate A and B.

In Eq. 8, the relationship between U and the round is shown. U1 and U2 are associated with round 1 (Ntx=1), U3 and U4 are associated with round 2 (Ntx=2), and so on, till Un−1 and Un are associated with round n/2 (Ntx=n/2). In other words, each round has a pair of possible unavailability intervals.

In Eq. 9, when the sleep window of Tv1(X) minus U1, which represents the duration of the second unavailability interval for a round, is greater than the duration of the sleep window of Tv2(Y), then also set B=Y for that round. B is the second possible unavailability interval of the round. In this case, the part of the unavailability interval B that overlaps part of the listening window of Tv2(Y) is subtracted from that unavailability interval and added to the availability interval v1.

In Eq. 10, when the sleep window of Tv2(Y) plus U0 is greater than or equal to the duration of the sleep window of Tv2(Y), A will be set to Y for that round, which is usually the case unless Uo+Y is also greater than X duration. A is the first possible unavailability interval of the round. If Uo+Y is greater than X, Eq. 4 is applied, otherwise if Uo+Y is greater than or equal to Y, Eq. 10 is applied by setting the first unavailability interval to Y.

In Eq. 11, the possible unavailability intervals of each round, A and B, can be calculated. Each round has a pair of possible unavailability intervals. The two intervals, A and B, represent the unavailability interval gain for each round when aligning the sleep windows and listening windows of the two Type 2 PSCs. The gain is measured against the unavailability when the two Type 2 PSCs are started at the same time, in other words, when Uo equals zero. A represents the unavailability from (Y+Uo), (Y+U2) . . . (Y+Un−2). B represents the unavailability from (X−U1), (X−U3) . . . (X−Un−1) with n=2*Ntx (rounds). A and B may be represented as a pair, e.g., (A, B).

In Eq. 11, if either A or B is a negative number, then that A or B will be set to zero, and the next availability v1 or v2 will be reduced by the negative value that was found for A or B before A or B was set to zero. In other words, every time there is a negative unavailability interval followed by an availability interval, the availability interval will be decreased by the negative unavailability interval.

For n greater than 1, each Un depends in part on the value of Un−1, back to Uo. Because A and B depend on the value of Un−2 and Un−1, respectively, a change in Uo may produce different A and B for n greater or equal to 2. In every round, the total unavailability interval is equal to A+B and the total availability interval is equal to v1+v2. In one exemplary embodiment, v1 and v2 may be adjusted per Eq. 4 and Eq. 9.

Therefore, selecting various values of Uo and applying the above relationships leads to the result that the availability interval can be decreased only in the first cycle. The second and subsequent cycles will have the same duration of total availability interval as when Uo=0. To take advantage of the translations being isomorphic to one another, the alignment for two Type 2 PSCs may be defined to be the same as when the longer unavailability intervals are at the start of a cycle. The alignment will lead to a better distribution of the availability intervals. Except for the first cycle, the alignment will not reduce the total length of availability intervals.

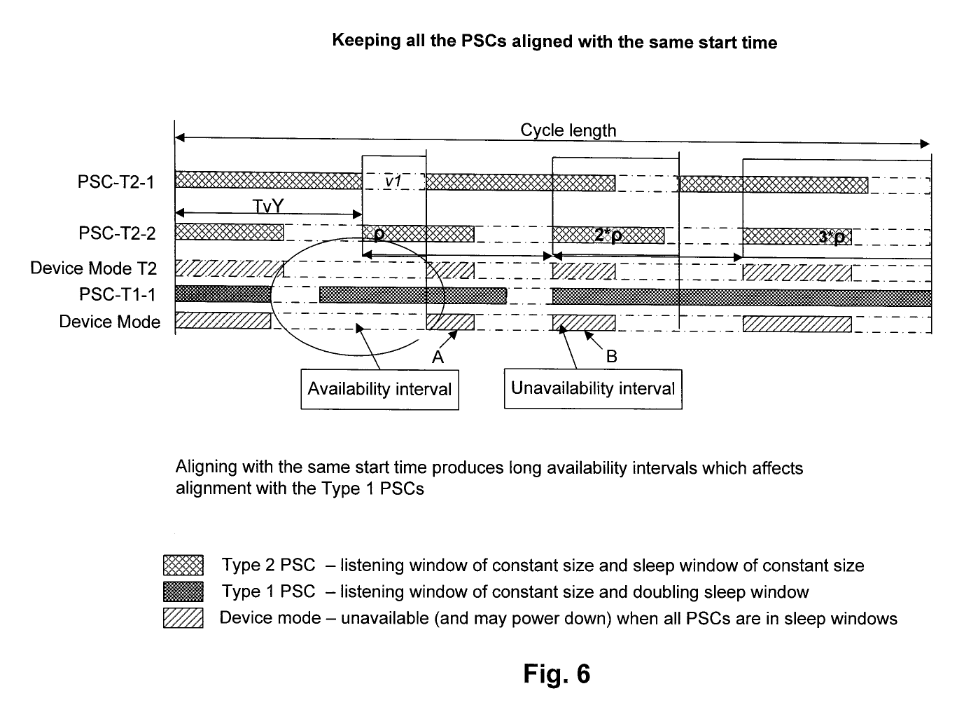

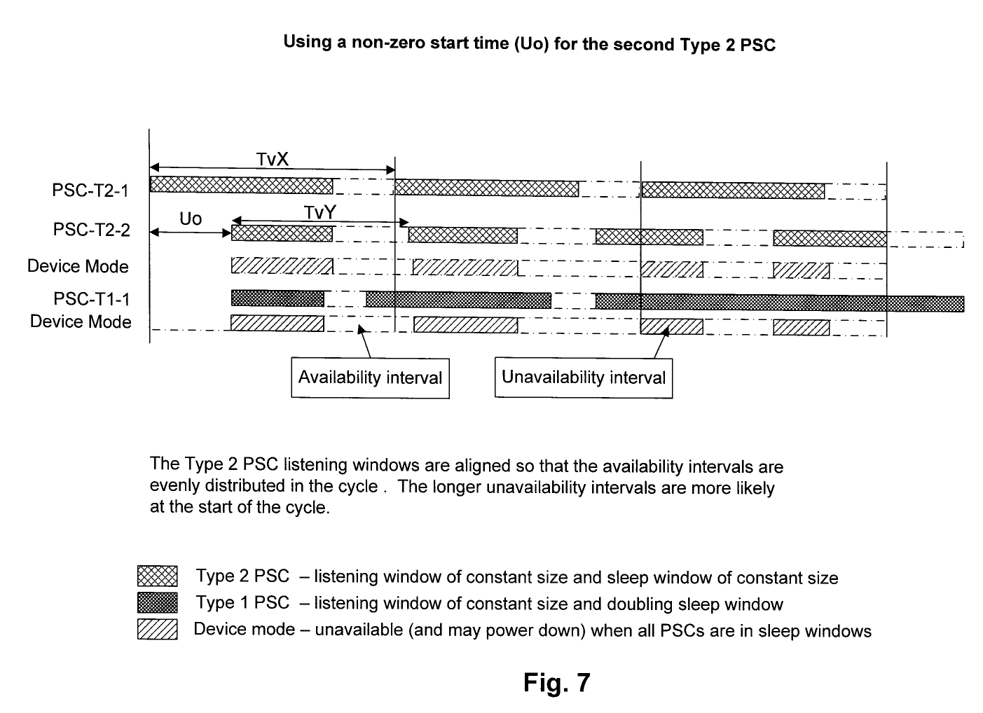

FIG. 6 is an exemplary diagram including a horizontal time axis, illustrating availability and unavailability intervals of a mobile device, e.g., MS 130, based on sleep and listening windows of two Type 2 PSCs, PSC-T2-1 and PSC-T2-2, and one Type 1 PSC, PSC-T1-1, that are aligned by sleep window start times. FIG. 7 is an exemplary diagram including a horizontal time axis, illustrating availability and unavailability intervals of a mobile device, e.g., MS 130, based on sleep and listening windows of two Type 2 PSCs, PSC-T2-1 and PSC-T2-2, and one Type 1 PSC, PSC-T1-1, that are aligned to place the longer unavailability intervals at the start of the cycle. Both FIG. 6 and FIG. 7 disclose the same two Type 2 PSCs, PSC-T2-1 and PSC-T2-2, and the same Type 1 PSC, PSC-T1-1, however, in FIG. 7, the PSCs are aligned because the longer unavailability intervals are at the start of the cycle. Longer unavailability intervals at the start of a cycle may produce a benefit when a Type 2 PSC drops out unexpectedly. Longer unavailability intervals at the start of a cycle may also provide more consistent unavailability intervals. Alignment further includes avoiding long availability intervals both at the start of and during a cycle to improve unavailability intervals when three or more PSCs are aligned. When the method is adapted to include aligning three or more Type 2 PSCs, long availability intervals will be added too, increasing the length of the availability intervals. To optimize the unavailability of the device, a method is needed suitable for PSCs with different listening and sleep window sizes. Additionally, the method should be designed to align all the rounds of a PSC, even for randomly selected base sleep window sizes. The method should provide alignment for multiple Type 1 PSCs or multiple Type 2 PSCs, or the combination of multiple Type 1 PSCs and multiple Type 2 PSCs. The method should offer a solution for realistic traffic patterns of PSCs of a wireless network, such as WiMax.

In one exemplary embodiment, one set of alignment rules for two Type 2 PSCs may include the following:

If Tv1(X)=Tv2(Y) or Gcd(Tv1(X), Tv2(Y))=Tv2(Y), then Uₒ=0 Eq. 12

If Gcd(Tv1(X), Tv2(Y))=1 and X>Y, and if v2>v1,

then Uₒ=X−Y, else Uₒ=Tv1(X)−Tv2(Y) Eq. 13

If Gcd(Tv1(X), Tv2(Y))=1 but X≦Y (meaning v2<v1 to verify PSC1>PSC2 and Gcd=1 conditions), then Uₒ=Tv1(X)−Tv2(Y) Eq. 14

If Gcd(Tv1(X), Tv2(Y))≠1 and smaller than Tv2(Y), and

If [X>Y or (Y>X and v1>v2)], then Uₒ=|X−Y|

Else Uₒ=Tv1(X)−Tv2(Y)

If Uₒ>v2, then Uₒ=v2 (only applicable to Gcd≠1) Eq. 15
wherein:

TABLE 2
Definitions of Variables for Eq. 13 to Eq. 16

| | |
|---|---|
| Tv1(X) | Duration of a Type 2 PSC X |
| Tv2(Y) | Duration of a Type 2 PSC Y |
| Gcd(L, J) | Greatest common divisor of L and J |
| U_{O} | Difference between the start times of Tv1(X) and Tv2(Y) |
| X | Sleep window of Tv1(X) |
| Y | Sleep window of Tv2(Y) |
| v1 | Listening window of Tv1(X) |
| v2 | Listening window of Tv2(Y) |

Eq. 12. shows that when the Gcd is equal to the second Type 2 PSC, Tv2(Y), or the two Type 2 PSCs have the same length, then the two Type 2 PSCs are started at the same time. Because the listening windows will be at the end of each of the Type 2 PSCs, the minimum availability interval is created when the overlap of the two listening windows is maximized.

Eq. 13 shows that when the Gcd is equal to one, the sleep window X is greater than the sleep window Y, and the listening window v2 is greater than the listening window v1, the alignment is set such that the start time Uo is equal to the sleep window X minus the sleep window Y. The start of the listening windows of the two Type 2 PSCs will be aligned in the first round. The two Type 2 PSC will line up once per cycle, because the sleep window X is greater than the sleep window Y, and the listening window v2 is greater than the listening window v1. If the Gcd is equal to one, the sleep window X is greater than the sleep window Y, but if the listening window v2 is less than or equal to the listening window v1, the alignment is set such that the start time Uo is equal to the length of PSC Tv1 (X) minus the length of PSC Tv2(Y). As discussed previously, a cycle is the duration before two Type 2 PSCs repeat the same spatial relationship with respect to each other. A round is every translation of X which equals Tv1(X). In other words, a cycle is composed of Ntx rounds of Tv1(X) and Nty rounds of Tv2(Y).

In Eq. 13, if the listening window v2 is greater than the listening window v1, aligning the starts of the listening windows v1 and v2 in the first round will “shift” small unavailability intervals that would fall at the beginning of the cycle (first rounds), if the start of the two Type 2 PSCs were aligned, and locate them in later rounds in the cycle. This will also reduce the length of the availability intervals in the first two rounds and improve the distribution of the unavailability intervals for almost half the cycle. If the start of the two Type 2 PSCs were aligned, small unavailability intervals may occur at the start of the cycle and the availability intervals will be longer in the first rounds, compared to aligning the starts of the listening windows v1 and v2 in the first round. In other words, aligning the ends of listening windows does not meet the condition of alignment discussed above, such as placing the longer unavailability intervals at the start of a cycle to provide more consistent unavailability intervals, and avoiding long availability intervals both at the start of and during a cycle to improve unavailability intervals when three or more PSCs are aligned.

In Eq. 13, if the listening window v2 is less than or equal to the listening window v1, aligning the ends of the listening windows v1 and v2 in the first round will reduce the duration of the unavailability intervals in the first two rounds of a cycle, and “shift” small unavailability intervals that would normally fall at the beginning of the cycle, and locate them in later rounds in the cycle. The duration and distribution of the unavailability intervals is improved for almost half of the cycle length. In other words, aligning the starts of the listening windows v1 and v2 in the first round does not meet the condition of alignment discussed above, such as placing the longer unavailability intervals at the start of a cycle to provide more consistent unavailability intervals, and avoiding long availability intervals both at the start of and during a cycle to improve unavailability intervals when three or more PSCs are aligned. When Gcd is equal to one, a trade-off is made between decreasing the total amount of unavailability (when Uo>v2) compared to when Uo=0 and improving the distribution of unavailability intervals and decreasing the availability intervals in the first two rounds.

Eq. 14 shows that when the Gcd is equal to one, and the sleep window X is less than or equal to the sleep window Y, the alignment is set such that the start time Uo is equal to the length of PSC Tv1(X) minus the length of PSC Tv2(Y). When the Gcd is equal to one, and the sleep window X is less than the sleep window Y, the listening window v2 is less than the listening window v1. The listening window v2 is less than the listening window v1 to insure the length of PSC Tv1(X) is not greater than the length of PSC Tv2(Y). The ends of the listening windows of the two Type 2 PSCs will be aligned in the first round. In Eq. 14, aligning the ends of the listening windows v1 and v2 in the first round will reduce the duration of the unavailability intervals in the first two rounds of a cycle. The duration and distribution of the unavailability intervals is improved for almost half of the cycle length. In other words, aligning the starts of the listening windows v1 and v2 in the first round does not meet the condition of alignment discussed above, such as placing the longer unavailability intervals at the start of a cycle to provide more consistent unavailability intervals, and avoiding long availability intervals both at the start of and during a cycle to improve unavailability intervals when three or more PSCs are aligned. When Gcd is equal to one, a trade-off is made between decreasing the total amount of unavailability (when Uo>v2) compared to when Uo=0 and improving the distribution of unavailability intervals and decreasing the availability intervals in the two first rounds.

Eq. 15 covers all other cases not covered in Eqs. 12, 13, and 14, that is, when the Gcd is not equal to one or the length of Tv2(Y). If Tv1 (X) is greater than Tv2(Y), the Gcd cannot be greater than Tv2(Y). If the Gcd is not equal to one or the length of Tv2(Y) and the sleep window X is greater than the sleep window Y, then the alignment is set such that the start time Uo is equal to the absolute value of the sleep window X minus the sleep window Y. The start of the listening windows of the two Type 2 PSCs will be aligned in the first round. Likewise, if the sleep window Y is greater than the sleep window X and the listening window vl is greater than the listening window v2, then the alignment is set such that the start time Uo is equal to the absolute value of the sleep window X minus the sleep window Y. The start of the listening windows of the two Type 2 PSCs will be aligned in the first round. If the Gcd is not equal to one or the length of Tv2(Y), and none of the above subconditions are met, the alignment is to set the start time Uo equal to the length of PSC Tv1(X) minus the length of PSC Tv2(Y). The ends of the listening windows of the two Type 2 PSCs will be aligned in the first round. In both cases, as discussed above for Eq. 13, the decision to align on the start of the listening windows or align on the ends of the listening windows is based on providing alignment for the particular characteristics of the two Type 2 PSCs.

In general, when Gcd is not equal to one or the length of Tv2(Y), and the start time Uo is greater than the listening window v2, the unavailability interval is decreased by the start time minus the listening window (Uo−v2) in the first cycle. When Uo>v2, setting Uo=v2 represents a tradeoff between increasing the consistency of the unavailability intervals and the amount of availability intervals at the beginning of a cycle. If the start time Uo is not decreased by the start time minus the listening window, the total unavailability intervals are reduced, and the distribution and length of unavailability intervals in the cycle is not optimized. Except in the cases where the Gcd≠1, setting Uo=v2 does not reliably result in improved alignment. When Gcd=1 and Uo>v2, not setting Uo=v2 represents a tradeoff between reducing the total unavailability intervals in the first cycle and a better distribution of the unavailability intervals at the beginning of future cycles. The next cycle will start with a small unavailability interval of Uo−v2 length, but will be followed by a more distributed pattern of unavailability intervals.

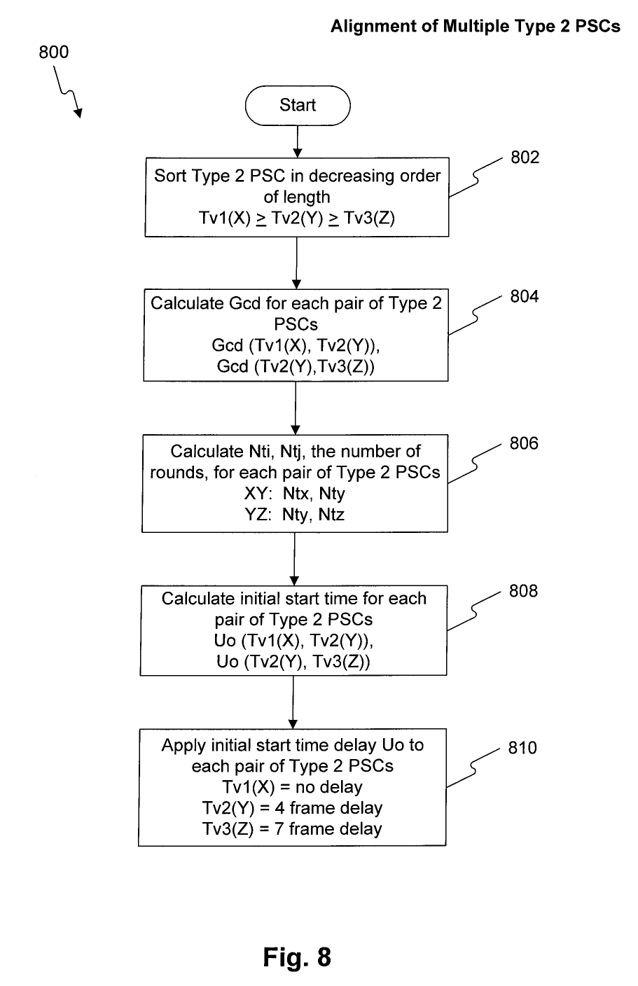

FIG. 8 shows a flow chart 800 illustrating an exemplary method to align three or more Type 2 PSCs. Alignment of multiple Type 2 PSCs 800 is used to produce an alignment of three or more Type 2 PSCs.

Step 802 sorts the Type 2 PSCs in order of decreasing duration. In other words, the shortest Type 2 PSC will be last on the list, and the longest Type 2 PSC will be first on the list. The Type 2 PSCs are sorted in order of decreasing respective durations in ranked pairs. As a result, for example, the longest Type 2 PSC is paired with the second longest Type 2 PSC to make the first Type 2 PSC ranked pair, the second longest Type 2 PSC is paired with the third longest Type 2 PSC to make the second Type 2 PSC ranked pair, etc. For example, if Tv1(X)=16 frames, Tv2(Y)=12 frames, and Tv3(Z)=9 frames, the order of decreasing duration would be Tv1(X), Tv2(Y), and Tv3(Z). Two Type 2 PSC ranked pairs would be made. The first Type 2 PSC ranked pair would be composed of Tv1(X) and Tv2(Y). The second Type 2 PSC ranked pair would be composed of Tv2(Y) and Tv3(Z).

Step 804 calculates the Gcd for each Type 2 PSC ranked pair in step 802. In other words, there should be one less Gcd than the total number of Type 2 PSCs. Continuing the example, if Tv1(X)=16 frames, Tv2(Y)=12 frames, and Tv3(Z)=9 frames, then 2 Gcds would be calculated, Gcd(Tv1(X), Tv2(Y)) and Gcd(Tv2(Y), Tv3(Z)). The Gcd(Tv1(X), Tv2(Y)) is equal to 4 frames and the Gcd(Tv2(Y), Tv3(Z)) is equal to 3 frames.

Step 806 calculates the number of rounds, Nti and Ntj, for each Type 2 PSC ranked pair. The number of rounds is calculated from the Gcd for each Type 2 PSC ranked pair. In other words, the number of rounds Nti and Ntj for each Type 2 PSC ranked pair to complete a cycle of the Type 2 PSC ranked pair is calculated, as described earlier in connection with aligning two Type 2 PSCs. Continuing the example, where Tv1(X)=16 frames, Tv2(Y)=12 frames, and Tv3(Z)=9 frames, and Gcd(Tv1(X), Tv2(Y))=4 frames and Gcd(Tv2(Y), Tv3(Z))=3 frames, the numbers of rounds for the Type 2 PSC ranked pair composed of Tv1(X) and Tv2(Y) are Ntx=12/4=3 rounds and Nty=16/4=4 rounds. Likewise, the numbers of rounds for the Type 2 PSC ranked pair composed of Tv2(Y) and Tv3(Z) are Nty=9/3=3 rounds and Ntz=12/3=4 rounds.

Step 808 calculates the start times for each Type 2 PSC ranked pair. In other words, for each Type 2 PSC ranked pair, a Uo is determined based on Eqs. 12 to 15. Continuing the example, Tv1(X)=16 frames, Tv2(Y)=12 frames, Tv3(Z)=9 frames. X=11 frames, v1=5 frames, Y=8 frames, v2=4 frames, Z=6 frames and v3=3 frames. To calculate the Uo for the Type 2 PSC ranked pair composed of Tv1(X) and Tv2(Y), Eq. 15 is applied to determine that Uo_{xy}=3 frames (|X−Y|=>11−8=3 which is smaller than v2=4). To calculate the Uo for the Type 2 PSC ranked pair composed of Tv2(Y) and Tv3(Z), Eq. 15 is applied to determine that Uo_{yz}=2 frames (from |X−Y|=>8−6=2 which is smaller than v3=3).

In step 810, the Uo is applied to the shortest member of each Type 2 PSC ranked pair, in succession, from longest to shortest, or from shortest to longest, or in any other logical order. In other words, the longer Type 2 PSC will start first, followed by the shorter Type 2 PSC. Continuing the example, where Tv1(X)=16 frames, Tv2(Y)=12 frames, Tv3(Z)=9 frames, Uo_{xy}=3 frames, and Uo_{yz}=2 frames, Tv1(X) will start at time 0, Tv2(Y) will start at 0+Uo_{xy}, (e.g., 0+3 frames), and Tv3(Z) will start after Tv2(Y), at 0+Uo_{yz}, +Uo_{xy} (e.g., 0+5 frames). It does not matter for the final result in which order the Uo are applied, as long as Uo for each Type 2 PSC ranked pair is applied to the shorter member of each Type 2 PSC ranked pair.

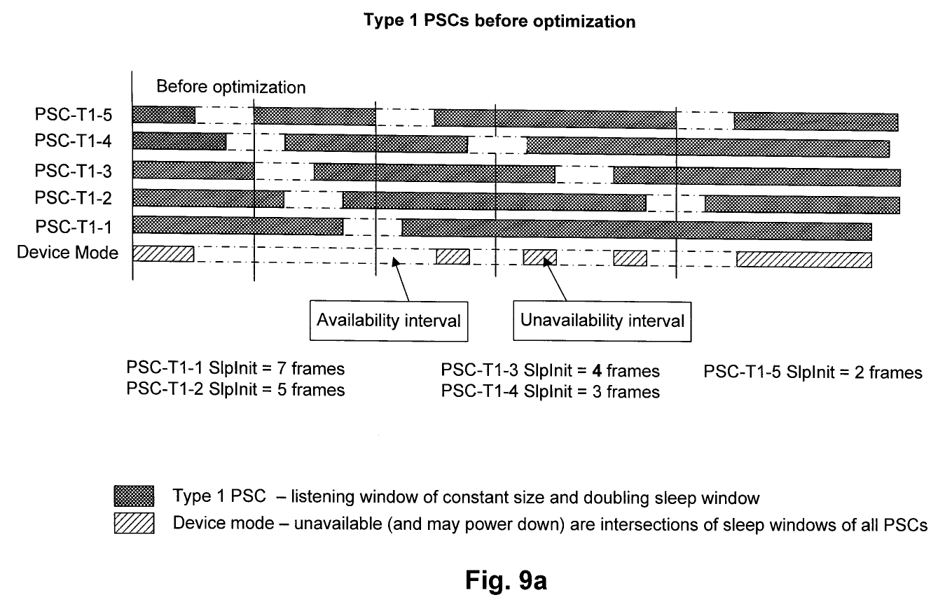

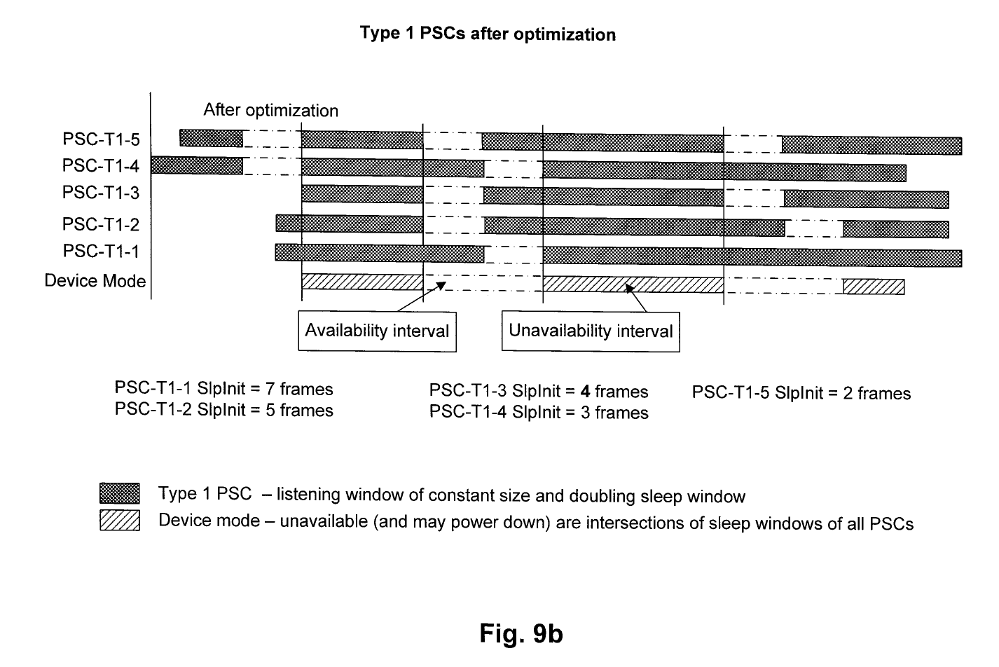

FIG. 9a is an exemplary diagram including a horizontal time axis, illustrating availability and unavailability intervals of a mobile device, e.g., MS 130, based on sleep and listening windows of five Type 1 PSCs that are aligned by initial sleep window start time. FIG. 9b is an exemplary diagram including a horizontal time axis, illustrating availability and unavailability intervals of a mobile device, e.g., MS 130, based on sleep and listening windows of five Type 1 PSCs that are aligned. As shown in FIGS. 9a and 9b, a Type 1 PSC has a fixed length listening window alternating with sleep windows, where each sleep window is twice the size of the previous sleep window, up to some maximum sleep window size. In a Type 1 PSC, the initial (or first) sleep window is longer than or equal to the fixed length listening window. The lengths of Type 1 PSCs, Type 1 PSC listening windows, and Type 1 PSC sleep windows may be measured in frames. Generally, the number of Type 1 PSCs are expected to be relatively small as compared to the number of Type 2 PSCs, and after the first few rounds, their sleep windows are expected to be long compared to their listening windows. Type 1 PSCs are composed primarily of BE and NRT-VR connections. As shown in FIGS. 9a and 9b, for one Type 1 PSC, the initial sleep window is called SlpInit1 for PSC-T1-1, SlpInit2 for PSC-T1-2, etc. It will be assumed for a pair of Type 1 PSCs, the initial sleep window of PSC-T1-1 is greater than or equal to the initial sleep window of PSC-T1-2, as shown below in Eq. 16. A Type 1 PSC listening window can be represented as vT1₁. For PSC-T1-1, the listening window is vT1₁, and for PSC-T1-2 the listening window is vT1₂.

SlpInit1≧SlpInit2 Eq. 16
wherein: SlpInit1 is the initial sleep window of a Type 1 PSC, PSC-T1-1
   SlpInit2 is the initial sleep window of a Type 1 PSC, PSC-T1-2

One set of alignment rules for two Type 1 PSC is as follows:

If SlpInit1/SlpInit2=2, then Uₒ=To+SlpInit2+vT1₂ Eq. 17

If SlpInit1/SlpInit2≠2 and SlpInit1−SlpInit2=Odd,

then Uₒ=SlpInit1−SlpInit2 Eq. 18

If SlpInit1/SlpInit2≠2 and SlpInit1SlpInit2=Even, then Uₒ=0 Eq. 19
wherein:

TABLE 3
Definitions of Variables for Eq. 17 to Eq. 19

| | |
|---|---|
| SlpInit1 | Initial sleep window of a Type 1 PSC, PSC-T1-1 |
| SlpInit2 | Initial sleep window of a Type 1 PSC, PSC-T1-2 |
| U_{O} | Difference between the start times of PSC-T1-1 and PSC-T1-2 |
| To | Start time of a Type 1 PSC, PSC-T1-1 |
| vT1₂ | Listening window of a Type 1 PSC, PSC-T1-2 |

In Eq. 17, when SlpInit1 divided by SlpInit2 equals 2, the first initial sleep window is twice the length of the second initial sleep window. To optimize the alignment of two Type 1 PSCs with this relationship, the start time Uo of the first initial sleep window is set to when the second initial sleep window of Type 1 PSC is ready to start its second sleep window, which is equal to the first initial sleep window (SlpInit1=2*SlpInit2). In FIG. 9b, PSC-T1-3 SlpInit3 is twice the length of PSC-T1-5 SlpInit5, so that the PSC-T1-3 start time would be after the start time of PSC-T1-5 by SlpInit5 plus the listening window of PSC-T1-5 (vT1₅).

In Eq. 18, when SlpInit1 divided by SlpInit2 does not equal 2, and SlpInit1 minus SlpInit2 is an odd number of frames, the Type 1 PSC with the shorter SlpInit is started after SlpInit1 minus SlpInit2 frames. In FIG. 9b, PSC-T1-4 SlpInit4 is not twice the length of PSC-T1-5 SlpInit5, and SlpInit4 minus SlpInit5 is an odd number of frames (3-2). Therefore, applying Eq. 18, PSC-T1-5 is started at SlpInit4 minus SlpInit5, that is, one frame (3-2) after PSC-T1-4.

In Eq. 19, when SlpInit1 divided by SlpInit2 does not equal 2, and SlpInit1 minus SlpInit2 is an even number of frames, both Type 1 PSCs are started at the same time. In FIG. 9b, PSC-T1-1 SlpInit1 is not twice the duration of PSC-T1-2, and SlpInit1 minus SlpInit2 is an even number of frames (7-5). Therefore, applying Eq. 19, PSC-T1-1 and PSC-T1-2 are started at the same time.

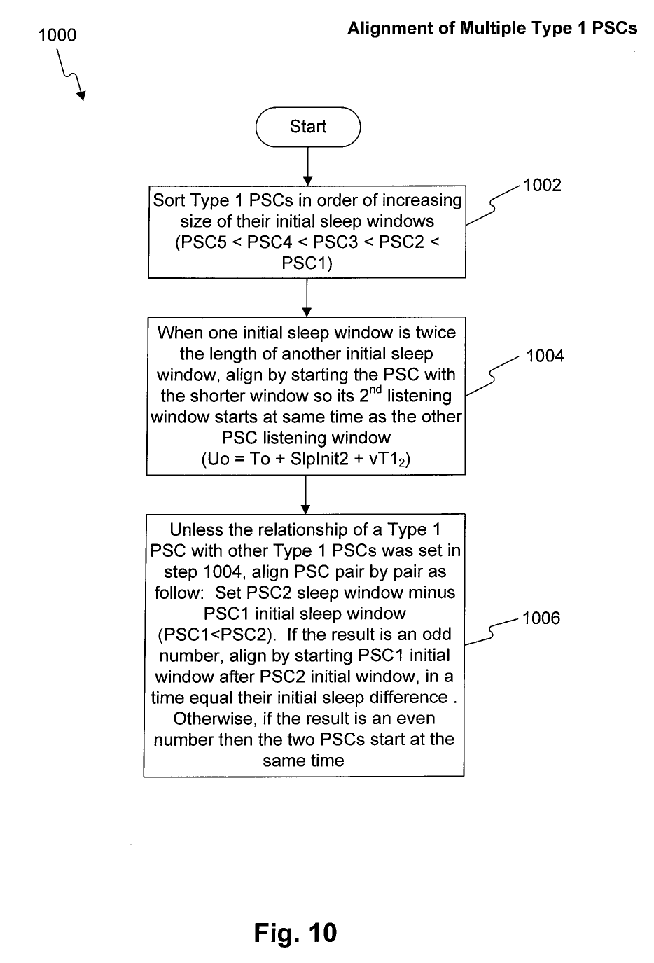

FIG. 10 shows a flow chart 1000 illustrating an exemplary set of steps to align three or more Type 1 PSCs. To align three or more Type 1 PSCs, the following method may be used to produce an alignment of multiple Type 1 PSCs as illustrated in FIG. 9b.

Step 1002 sorts the Type 1 PSCs in order of increasing duration of their initial sleep window. In other words, the Type 1 PSC with the shortest initial sleep window will be first on the list, and the Type 1 PSC with the longest initial sleep window will be last on the list. The sorting of the Type 1 PSCs further includes sorting in order of increasing respective durations in ranked pairs, the shortest Type 1 PSC paired with the second shortest Type 1 PSC to make a first Type 1 PSC ranked pair, the second shortest Type 1 PSC paired with the third shortest Type 1 PSC to make a second Type 1 PSC ranked pair, etc. In an example, it is assumed that SlpInit1 through SlpInit5 are the initial sleep windows of Type 1 PSCs PSC-T1-1 through PSC-T1-5, respectively. If SlpInit1=7 frames, SlpInit2=5 frames, SlpInit3=4 frames, SlpInit4=3 frames, and SlpInit5=2 frames, then the order of Type 1 PSCs would be PSC-T1-5, PSC-T1-4, PSC-T1-3, PSC-T1-2, and PSC-T1-1. Further, four Type 1 PSC ranked pairs would be made. The first Type 1 PSC ranked pair would be composed of PSC-T1-5 and PSC-T1-4. The second Type 1 PSC ranked pair would be composed of PSC-T1-4 and PSC-T1-3. The third Type 1 PSC ranked pair would be composed of PSC-T1-3 and PSC-T1-2. The fourth Type 1 PSC ranked pair would be composed of PSC-T1-2 and PSC-T1-1.

Step 1004 applies Eq. 17 to all combinations of Type 1 PSCs for which the first initial sleep window is twice the length of the second initial sleep window. When two Type 1 PSCs have a relationship in which the first initial sleep window is twice the length of the second initial sleep window, the two Type 1 PSCs will be called a Type 1 PSC twice length pair. The start times of each Type 1 PSC twice length pair are fixed between the members of that Type 1 PSC twice length pair. Continuing the example, if SlpInit1=7 frames, SlpInit2=5 frames, SlpInit3=4 frames, SlpInit4=3 frames, and SlpInit5=2 frames, then SlpInit3 divided by SlpInit5 equals 2. Therefore, PSC-T1-3 and PSC-T1-5 are designated a Type 1 PSC twice length pair. Eq. 17 is applied to only the Type 1 PSC twice length pair of PSC-T1-3 and PSC-T1-5, where PSC-T1-5 has the shorter of the initial sleep windows. As shown in FIG. 9b, SlpInit3 is twice the length of SlpInit5. Thus, PSC-T1-3 would start after PSC-T1-5, i.e., after a time period equal to SlpInit5 plus the listening window of PSC-T1-5. The relationship between the start times of PSC-T1-3 and PSC-T1-5 is thereby fixed.

In step 1006 the rules of Eq. 18 and 19 would be applied to Type 1 PSC ranked pair by Type 1 PSC ranked pair, in the order established in step 1002. Where a relationship has already been established between a Type 1 PSC twice length pair, the operation of step 1006 would not alter that relationship. In other words, all Type 1 PSC ranked pairs are aligned according to Eq. 18 or 19 except when the longer SlpInit of the Type 1 PSC ranked pair's position was already set in Step 1004 to a Type 1 PSC whose position has been set in relation to the shorter SlpInit of the Type 1 PSC ranked pair's position.

Continuing the example in which SlpInit1=7 frames, SlpInit2=5 frames, SlpInit3=4 frames, SlpInit4=3 frames, and SlpInit5 =2 frames, SlpInit4 minus SlpInit5 equals 1 frame. Applying Eq. 18, since 1 is an odd number, PSC-T1-5 will start 1 frame after PSC-T1-4. Considering next the pair PSC-T1-4 and PSC-T1-3, where the relationship between PSC-T1-5 and PSC-T1-4 has been set, in step 1004, the relationship between PSC-T1-5 and PSC-T1-3 has been set, the relationship between PSC-T1-4 and PSC-T1-3 is known. Assuming the listening windows of all the Type 1 PSCs are 2 frames in duration, Eq. 17 only applies to the pair of PSC-T1-5 and PSC-T1-3, where PSC-T1-5 is the shorter of the initial sleep windows. PSC-T1-3 will start 4 frames after PSC-T1-5, and PSC-T1-3 will start 5 frames after PSC-T1-4. Turning to the next Type 1 PSC pair, PSC-T1-3 and PSC-T1-2, SlpInit2 minus SlpInit 3 equals 1. Applying Eq. 18, since 1 is an odd number, PSC-T1-3 will start 1 frame after PSC-T1-2, and PSC-T1-2 will start 3 frames after PSC-T1-5 and 4 frames after PSC-T1-4. Turning to the last Type 1 PSC pair, PSC-T1-2 and PSC-T1-1, SlpInit1 minus SlpInt2 equals 2. Applying Eq. 19, since 2 is an even number, PSC-T1-1 and PSC-T1-2 will start at the same time.

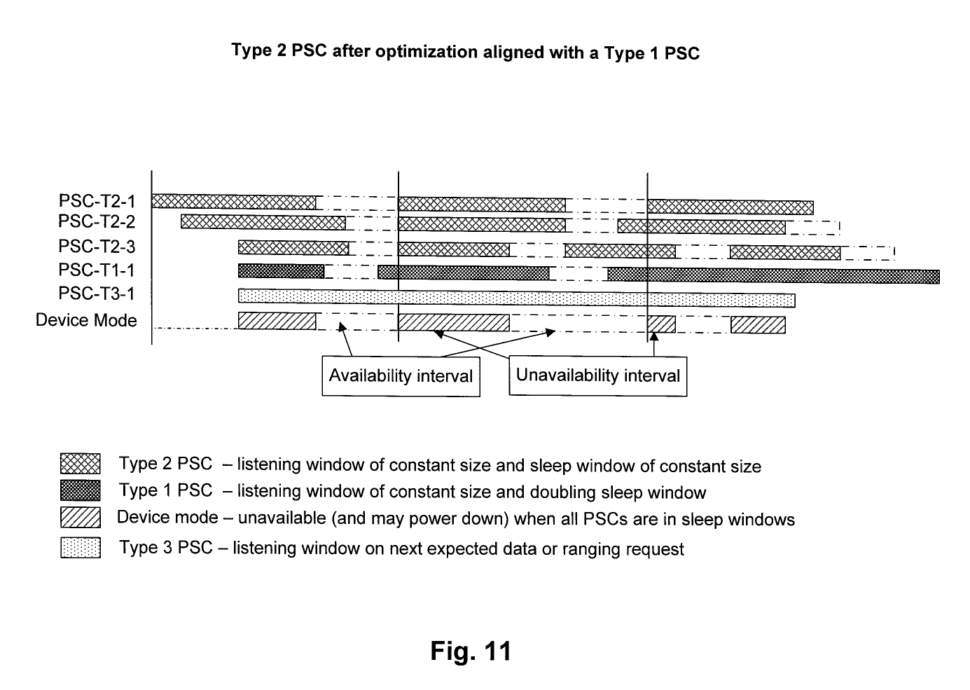

FIG. 11 is an exemplary diagram including a horizontal time axis, illustrating availability and unavailability intervals of a mobile device, e.g., MS 130, based on sleep and listening windows of multiple PSCs with different Types that are aligned. As shown in FIG. 11, when more than one Type of PSC is present on a device, those PSCs can be aligned.

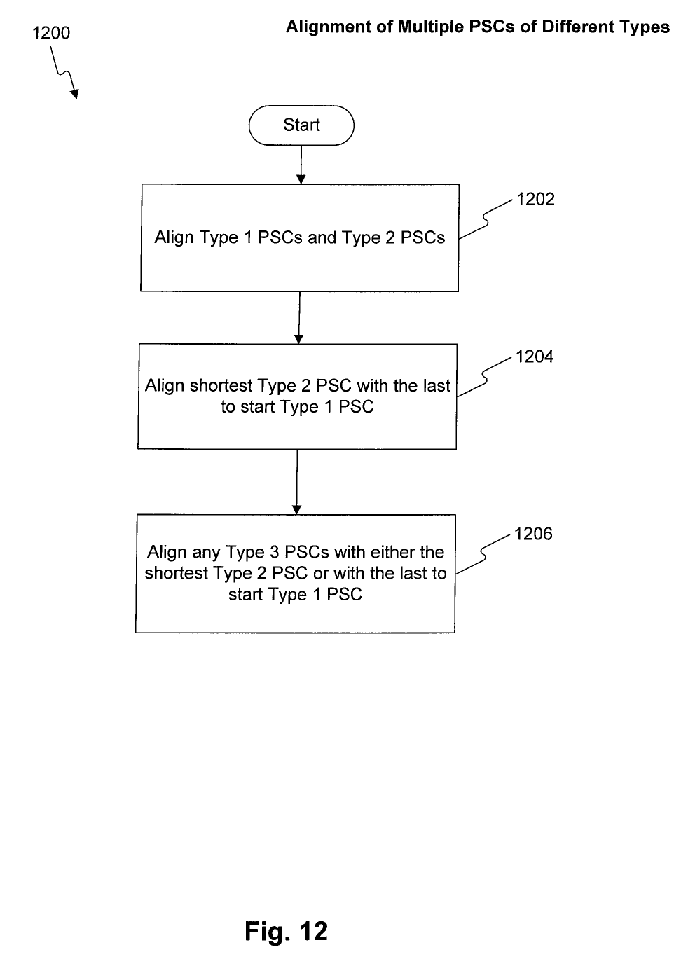

FIG. 12 is a flow chart 1200 illustrating an exemplary method to align multiple PSCs with different types. The exemplary method of flow chart 1200 may be used to align multiple PSCs.

In Step 1202, each type of PSC is aligned within its own type of PSC. In other words, all Type 1 PSCs are aligned using, for example, the method disclosed above in connection with FIG. 10. Likewise, all Type 2 PSCs are aligned using, for example, the method disclosed above, in connection with FIG. 8.

In Step 1204, the shortest Type 2 PSC and the last to start Type 1 PSC are aligned. The appropriate Eq. of the group of Eqs. 20, 21, 22, or 23 below is applied to align the shortest Type 2 PSC and the last to start Type 1 PSC.

If X>SlpInit1 and v1>vT1₁, then U_{o(Type1)}X−SlpInit1 Eq. 20.

If SlpInit1>X and vT1₁>v1, then U_{o(Type2)}=SlpInit1−X Eq. 21.

If X≧SlpInit1 and vT1₁≧v1, then start both PSCs at the same time Eq. 22.

If (X=SlpInit1 and v1>vT1₁) or (SlpInit1>X and v1≧vT1₁), then the PSC with the shortest length has a Uo=|Tv1(X)−PSC-T1-1| Eq. 23.
wherein:

TABLE 4
Definitions of Variables for Eq. 20 to Eq. 23

| | |
|---|---|
| X | Sleep window of the shortest Type 2 PSC, Tv1(X) |
| SlpInit1 | Initial sleep window of a Type 1 PSC, PSC-T1-1 |
| v1 | Listening window of the shortest Type 2 PSC, Tv1(X) |
| vT1₁ | Listening window of a Type 1 PSC, PSC-T1-1 |
| U_{O} | Difference between the start times of PSC-T1-1 and Tv1(X) |
| Tv1(X) | Duration of a Type 2 PSC = X + v1 |
| PSC-T1-1 | Duration of a Type 1 PSC, PSC-T1-1 |

Applying Eqs. 20 and 21, if the duration of the sleep window of one of the two types of PSCs is greater than the duration of the sleep window of the other type of PSC and the duration of the listening window of the PSC with greater sleep window is also greater than the duration of the listening window of the other type of PSC, then the shortest duration PSC will be started at a time equal to their sleep windows difference (sleep window-initial sleep window or vice versa) to align the beginning of their listening windows. In other words, if the duration of both the initial sleep window and listening window of the Type 1 PSC are greater than the respective durations of the sleep window and listening window of Type 2 PSC, or the duration of both the sleep window and listening window of Type 2 PSC are greater than the respective durations of the initial sleep window and listening window of the Type 1 PSC, then align the start of their listening windows. The start of the listening windows are aligned by taking the difference between the absolute value of the Type 2 PSC sleep window minus the initial sleep window of the Type 1 PSC, and adding that difference to the start time of the shorter type of PSC.

Applying Eq. 22, if the duration of the sleep window of the Type 2 PSC is greater than or equal to the duration of the sleep window of the Type 1 PSC and the duration of the Type 2 PSC listening window is less than or equal to the duration of the listening window of the Type 1 PSC, then both PSCs will be started at the same time. Because the sleep window of a Type 1 PSC doubles every round, the availability intervals will be evenly distributed and there will be more opportunities to improve the unavailability intervals.

Using Eq. 23, if among the Type 1 and Type 2 PSCs, none of the conditions of Eqs. 20, 21, or 22 have been met, then the shortest duration PSC is started at a time equal the difference of the two PSCs lengths (sleep+listen) to align the end of the two PSCs listening windows. In other words, if the duration of the sleep window of the Type 2 PSC and the duration of the initial sleep window of the Type 1 PSC are equal, and the duration of the listening window of the Type 2 PSC is greater than the duration of the listening window of the Type 1 PSC, or the duration of the initial sleep window of the Type 1 PSC is greater than the duration of the sleep window of the Type 2 PSC, and the duration of the listening window of the Type 2 PSC is greater than or equal to the duration of the listening window of the Type 1 PSC, then the ends of their listening windows will be aligned. More particularly, the ends of their listening windows are aligned by taking the difference between the absolute value of the Type 2 PSC duration minus the Type 1 PSC duration, and adding that difference to the start time of the shorter PSC.

In Step 1206, as shown in FIG. 12, any Type 3 PSCs may be aligned by matching the start time of the Type 3 PSC with the start time of the last to start PSC. The PSC may be either the last to start Type 1 PSC or the Type 2 PSC with the shortest duration. The Type 3 PSC will be aligned and have the same start time with one of the PSCs that has already been aligned. If the Type 3 PSC is aligned with a Type 2 PSC, the Type 3 PSC will be aligned with the PSC having the shortest duration. If the Type 3 PSC is aligned with a Type 1 PSC, the Type 3 PSC will be aligned with the PSC having the latest start time.

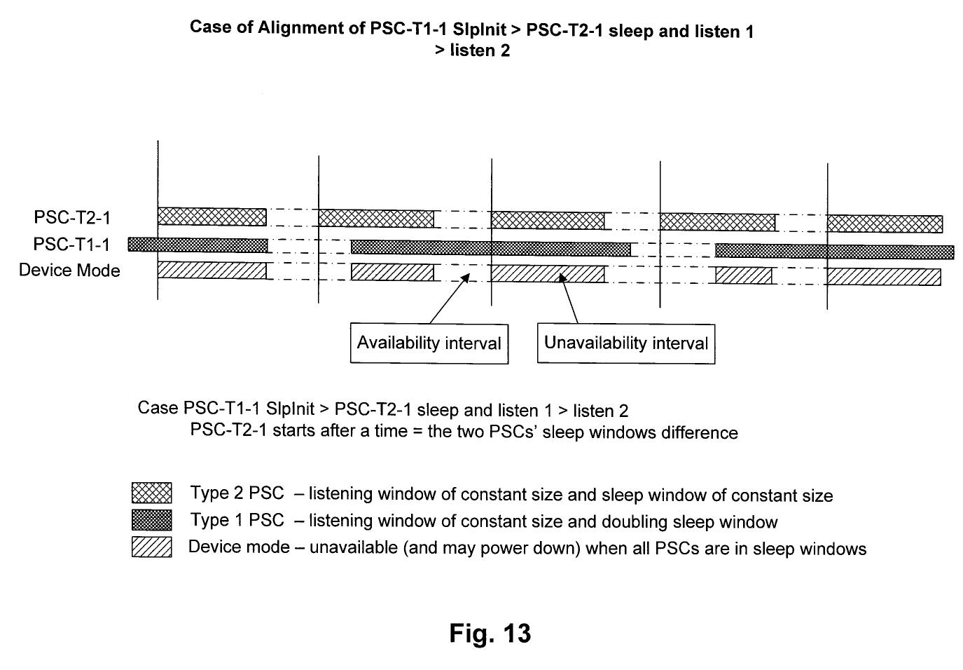

FIGS. 13-18 illustrate exemplary situations in which Step 1204 and Eqs. 20-23 are applied to the last to start Type 1 PSC, which may have various durations, and a Type 2 PSC with the shortest duration.

FIG. 13 is an exemplary diagram including a horizontal time axis, illustrating available and unavailable intervals of a mobile device, e.g., MS 130, based on sleep and listening windows of multiple PSCs. In particular, FIG. 13 shows a case in which the initial sleep window of the Type 1 PSC, PSC-T1-1, is greater than the sleep window of the Type 2 PSC, PSC-T2-1. The listening window of PSC-T1-1 is greater than the listening window of PSC-T2-1. Applying step 1204, Eq. 21 is used to determine that Uo, the delay in starting PSC-T2-1, is equal to the difference between the initial sleep window of PSC-T1-1 and the sleep window of PSC-T2-1. The start of the listening windows of PSC-T1-1 and PSC-T2-1 will begin at the same time. In this manner, the two PSCs are aligned.

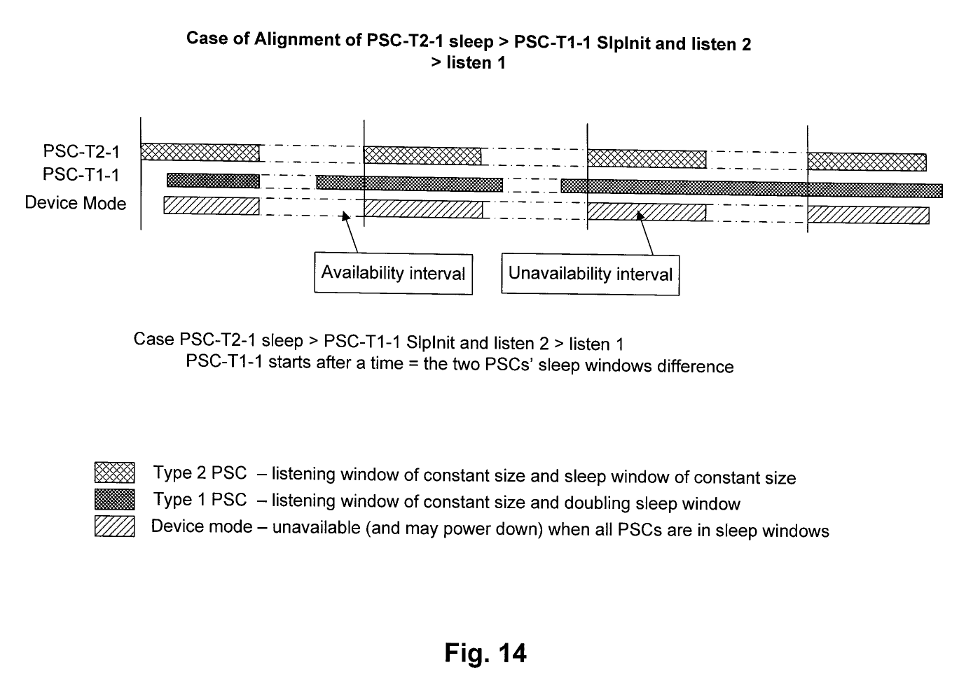

FIG. 14 is an exemplary diagram including a horizontal time axis, illustrating available and unavailable intervals of a mobile device, e.g., MS 130, based on sleep and listening windows of multiple PSCs. In particular, FIG. 14 shows a case in which the sleep window of the Type 2 PSC, PSC-T2-1, is greater than the initial sleep window of the Type 1 PSC, PSC-T2-1. The listening window of PSC-T2-1 is greater than the listening window of PSC-T1-1. Applying step 1204, Eq. 20 is used to determine that Uo, the delay in starting PSC-T1-1, is equal to the difference between the sleep window of PSC-T2-1 and the initial sleep window of PSC-T1-1. The listening windows of the PSC-T1-1 and PSC-T2-1 will start at the same time. In this manner, the two PSCs are aligned.

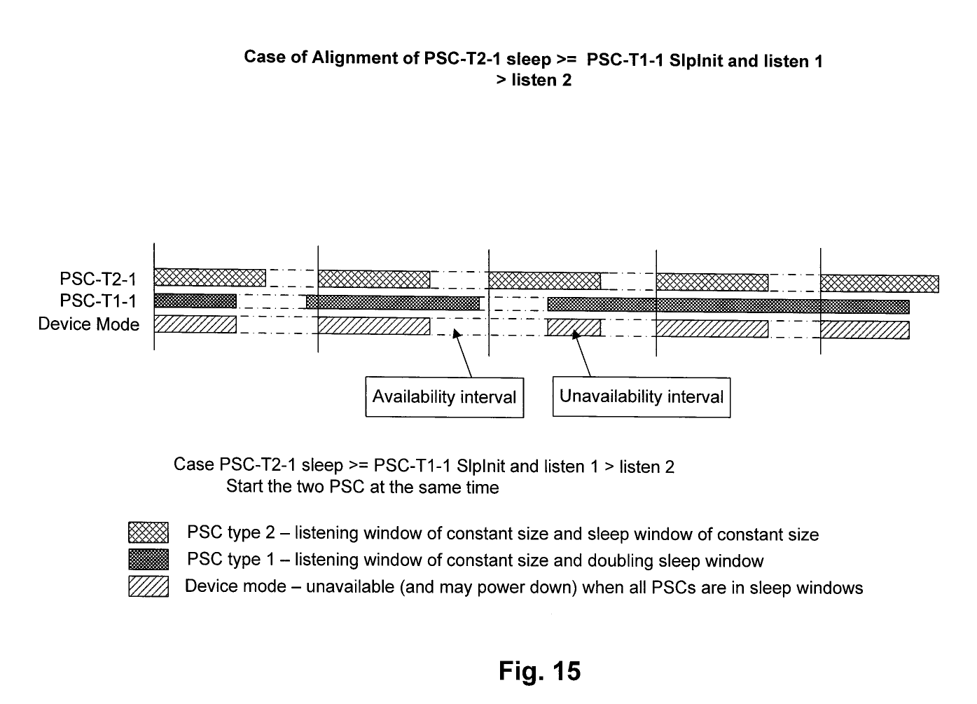

FIG. 15 is an exemplary diagram including a horizontal time axis, illustrating available and unavailable intervals of a mobile device, e.g., MS 130, based on sleep and listening windows of multiple PSCs. In particular, FIG. 15 shows a case in which the sleep window of the Type 2 PSC, PSC-T2-1, is greater than or equal to the initial sleep window of the Type 1 PSC, PSC-T1-1. The listening window of PSC-T1-1 is greater than the listening window of PSC-T2-1. Applying step 1204, Eq. 22 is used to determine that PSC-T1-1 and PSC-T2-1 are started at the same time, and the two PSCs are aligned.

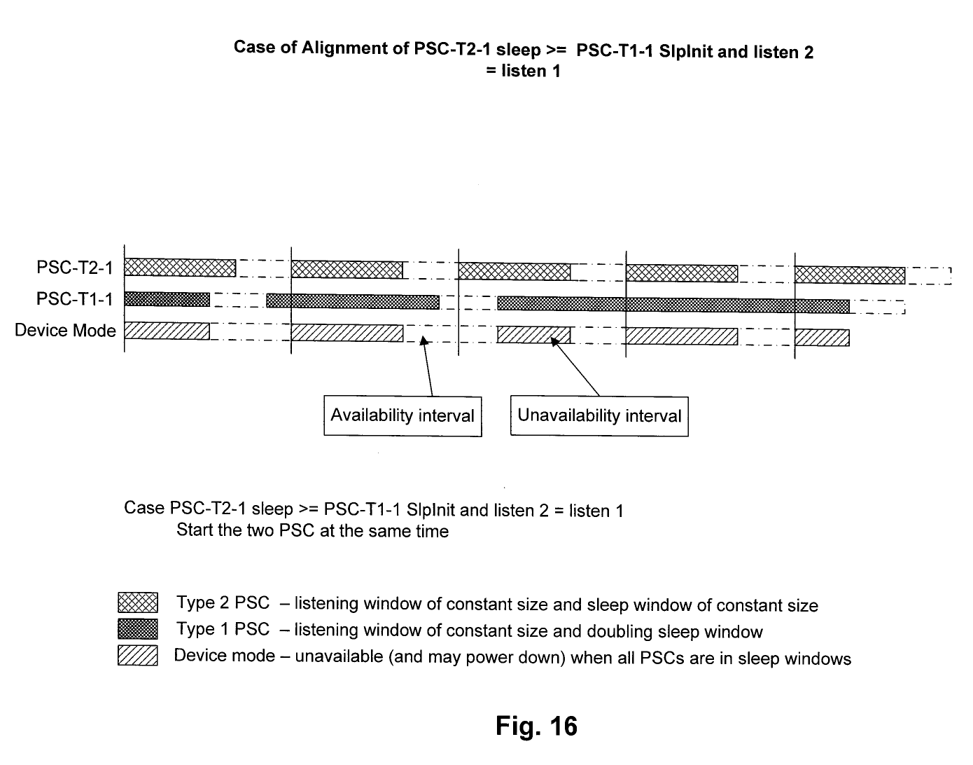

FIG. 16 is an exemplary diagram including a horizontal time axis, illustrating available and unavailable intervals of a mobile device, e.g., MS 130, based on sleep and listening windows of multiple PSCs. In particular, FIG. 16 shows a case in which the sleep window of the Type 2 PSC, PSC-T2-1, is greater than or equal to the initial sleep window of the Type 1 PSC, PSC-T1-1. The listening window of PSC-T1-1 is equal to the listening window of PSC-T2-1. Applying step 1204, Eq. 22 is used to determine that PSC-T1-1 and PSC-T2-1 are started at the same time, and the two PSCs are aligned.

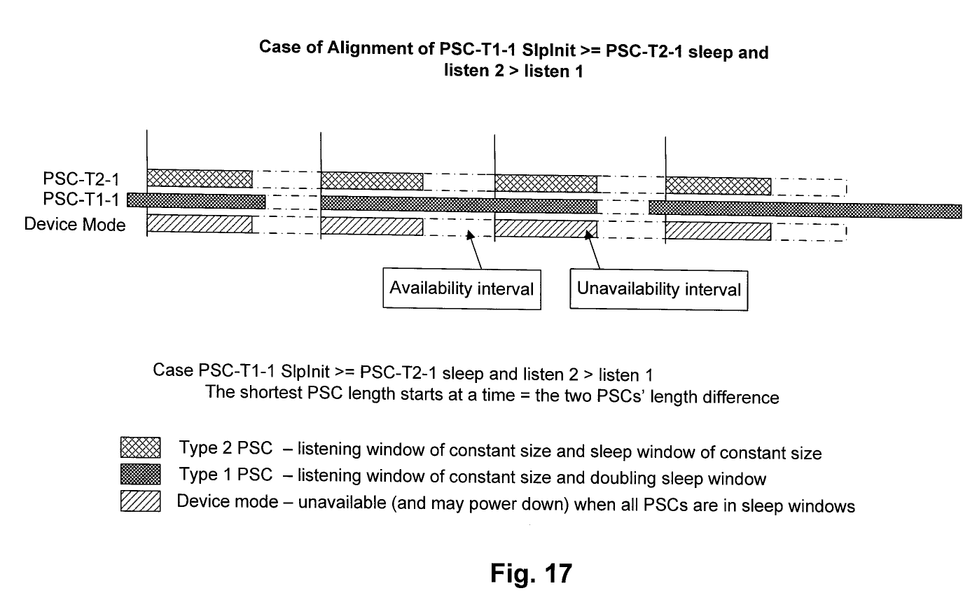

FIG. 17 is an exemplary diagram including a horizontal time axis, illustrating available and unavailable intervals of a mobile device, e.g., MS 130, based on sleep and listening windows of multiple PSCs. In particular, FIG. 17 shows a case in which the initial sleep window of the Type 1 PSC, PSC-T1-1, is greater than or equal to the sleep window of the Type 2 PSC, PSC-T2-1. The listening window of PSC-T2-1 is greater than the listening window of PSC-T1-1. Applying step 1204, Eq. 23 is used to determine that Uo, the delay in starting PSC-T2-1, is equal to the difference between the PSC-T1-1 length (sleep+listen) and the PSC-T2-1 length (sleep+listen). The listening windows of PSC-T1-1 and PSC-T2-1 will end at the same time, and the two PSCs are aligned.

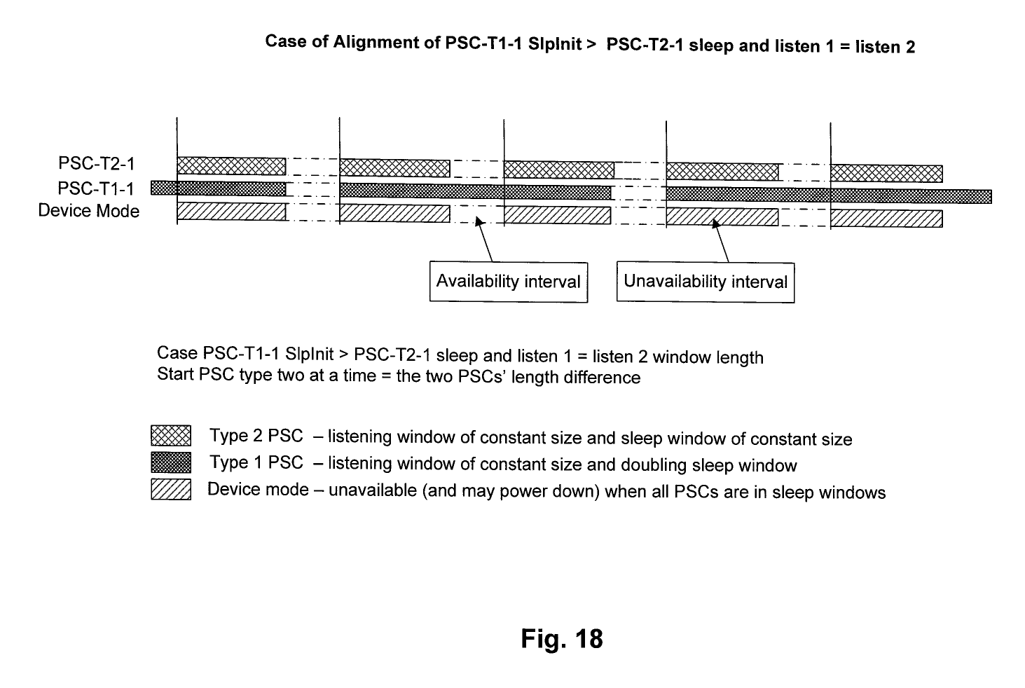

FIG. 18 is an exemplary diagram including a horizontal time axis, illustrating available and unavailable intervals of a mobile device, e.g., MS 130, based on sleep and listening windows of multiple PSCs. In particular, FIG. 18 shows a case in which the initial sleep window of the Type 1 PSC, PSC-T1-1, is greater than the sleep window of the Type 2 PSC, PSC-T2-1. The listening window of PSC-T2-1 is equal to the listening window of PSC-T1-1. Applying step 1204, Eq. 23 is used to determine that Uo, the delay in starting PSC-T2-1, is equal to the difference between the PSC-T1-1 length (sleep+listen) and the PSC-T2-1 length (sleep+listen). The listening windows of PSC-T1-1 and PSC-T2-1 will end at the same time, and the two PSCs are aligned.

Once the PSCs have been aligned, the plurality of PSCs, each associated power savings window size, the aligned PSCs, and the relative start times between PSCs, may be communicated to BS 110. In another exemplary embodiment, MS 130 may manage its own power management, and not communicate the plurality of PSCs, each associated power savings window size, the aligned PSCs, and the relative start times between PSCs, to BS 110. In a further exemplary embodiment, only the plurality of PSCs and each associated power savings window size may be communicated to BS 110.

It will be apparent to those skilled in the art that various modifications and variations can be made in the system and method for power savings in a wireless communications network. It is intended that the standard and examples be considered as exemplary only, with a true scope of the disclosed embodiments being indicated by the following claims and their equivalents.

1. A method for power savings in a wireless communications network, comprising:
selecting all Type 1 power savings classes, if present on a device;
selecting all Type 2 power savings classes, if present on the device;
selecting all Type 3 power savings classes, if present on the device;
aligning the selected Type 1 power savings classes of the device, if more than one Type 1 power savings class is selected;
aligning the selected Type 2 power savings classes of the device, if more than one Type 2 power savings class is selected;
aligning the two or more aligned Type 1 power savings classes or, if only one Type 1 power savings class is selected, the selected Type 1 power savings class, and the two or more aligned Type 2 power savings classes or, if only one Type 2 power savings class is selected, the selected Type 2 power savings class, if there is at least one selected Type 1 power savings class and at least one selected Type 2 power savings class; and
aligning the selected Type 3 power savings classes with the aligned Type 1 and Type 2 power savings classes, if there is at least one selected Type 3 power savings class and at least one Type 1 or Type 2 power savings class.

2. The method as in claim 1, further including communicating the alignment of any Type 1, Type 2, or Type 3 power savings classes to a base station.

3. The method as in claim 1, wherein:
each of the one or more Type 1 power savings classes has a series of equal fixed duration listening windows alternating with a series of sleep windows, and wherein each sleep window has twice a duration of a previous sleep window, up to a maximum sleep window duration, and an initial sleep window duration is greater than or equal to the listening window fixed duration;
each of the one or more Type 2 power savings classes has a series of equal fixed duration listening windows alternating with a series of equal fixed duration sleep windows and the sleep window duration is greater than the listening window duration; and
each of the one or more Type 3 power savings classes has a sleep window wherein durations and separations of an expected time period of activity and the sleep window is set based on an expected arrival of a next portion of data or next expected ranging request.

4. The method as in claim 1, wherein aligning the selected Type 1 power savings classes of the device includes:
sorting the selected Type 1 power savings classes in order of increasing duration of initial sleep windows of the selected Type 1 power savings classes to define Type 1 power savings class ranked pairs;
aligning as a Type 1 power savings class twice length pair two Type 1 power savings classes for which the initial sleep window of a first Type 1 power savings class of the Type 1 power savings class twice length pair has twice a duration of the initial sleep window of a second Type 1 power savings class of the Type 1 power savings class twice length pair, the aligning including starting the second Type 1 power savings class at a time equal to the initial sleep window duration of the first Type 1 power savings class plus a duration of a listening window of the first Type 1 power savings class; and
aligning two Type 1 power savings classes in the Type 1 power savings class ranked pair, Type 1 power savings class ranked pair by Type 1 power savings class ranked pair, in the sorted order of increasing duration of the initial sleep windows of Type 1 power savings classes, except when the aligning of the Type 1 power savings class ranked pair changes an alignment of any Type 1 power savings class twice length pair.

5. The method as in claim 4, wherein aligning two Type 1 power savings classes in the Type 1 power savings class ranked pair, Type 1 power savings class ranked pair by Type 1 power savings class ranked pair, in the sorted order of increasing duration of the initial sleep windows of the Type 1 power savings classes, includes:
aligning the Type 1 power savings class ranked pair, for which a difference between an initial sleep window of a first Type 1 power savings class and an initial sleep window of a second Type 1 power savings class of the Type 1 power savings class ranked pair is an odd number of frames, by starting the Type 1 power savings class of the Type 1 power savings class ranked pair having a shorter duration initial sleep window after starting of the Type 1 power savings class of the Type 1 power savings class ranked pair having a longer duration initial sleep window, at a time equal to a difference between respective durations of the initial sleep windows of the Type 1 power savings class ranked pair; and
aligning the Type 1 power savings class ranked pair, for which the difference between the initial sleep window of the first Type 1 power savings class and the initial sleep window of the second Type 1 power savings class of the Type 1 power savings class ranked pair is an even number of frames, by starting both Type 1 power savings classes of the Type 1 power savings class ranked pair at the same time.

6. The method as in claim 1, wherein aligning the selected Type 2 power savings classes of the device includes:
sorting the selected Type 2 power savings classes in order of decreasing respective durations of the selected Type 2 power savings classes into Type 2 power savings class ranked pairs;
determining a greatest common divisor for each Type 2 power savings class ranked pair, a greater duration Type 2 power savings class with its following Type 2 power savings class, in the sorted order of Type 2 power savings classes;
determining a difference between the respective durations for each Type 2 power savings class ranked pair, the greater duration Type 2 power savings class with its following Type 2 power savings class, in the sorted order of Type 2 power savings classes;
determining a number of rounds for each selected Type 2 power savings class to complete a cycle for each Type 2 power savings class ranked pair, the greater duration Type 2 power savings class with its following Type 2 power savings class, in the sorted order of Type 2 power savings classes;
determining a start time for each Type 2 power savings class ranked pair, the greater duration Type 2 power savings class with its following Type 2 power savings class, in the sorted order of Type 2 power savings classes; and
applying the determined start time for each Type 2 power savings class ranked pair.

7. The method as in claim 6, wherein determining a start time for each Type 2 power savings class ranked pair includes:
aligning a Type 2 power savings class ranked pair, in which the durations of the two Type 2 power savings classes are equal, by starting the two Type 2 power savings classes of the Type 2 power savings class ranked pair, at the same time;
aligning the Type 2 power savings class ranked pair, in which the greatest common divisor of the Type 2 power savings class ranked pair is equal to a Type 2 power savings class with the shorter duration of the Type 2 power savings class ranked pair, by starting the two Type 2 power savings classes of the Type 2 power savings class ranked pair, at the same time;
aligning the Type 2 power savings class ranked pair, in which the greatest common divisor of the Type 2 power savings class ranked pair is equal to one, a duration of a sleep window of a first Type 2 power savings class is greater than a duration of a sleep window of a second Type 2 power savings class of the Type 2 power savings class ranked pair, and the duration of the listening window of the second Type 2 power savings class is greater than a duration of the listening window of the first Type 2 power savings class of the Type 2 power savings class ranked pair, by starting the Type 2 power savings class having a shorter duration sleep window after the start of the Type 2 power savings class with a longer duration sleep window, at a time equal to a difference between respective durations of the sleep windows of the first and second Type 2 power savings classes of the Type 2 power savings class ranked pair;
aligning the Type 2 power savings class ranked pair, in which the greatest common divisor of the Type 2 power savings class ranked pair is equal to one, a duration of a sleep window of a first Type 2 power savings class is greater than a duration of a sleep window of a second Type 2 power savings class of the Type 2 power savings class ranked pair, and the duration of the listening window of the first Type 2 power savings class is greater than or equal to the duration of the listening window of a second Type 2 power savings class of the Type 2 power savings class ranked pair, by starting the Type 2 power savings class having the shorter duration sleep window after the start of the Type 2 power savings class with the longer duration sleep window, at a time equal to a difference between respective durations of the first and second Type 2 power savings classes of the Type 2 power savings class ranked pair;
aligning the Type 2 power savings class ranked pair, in which the greatest common divisor of the Type 2 power savings class ranked pair is equal to one and the duration of a sleep window of the first Type 2 power savings class is less than or equal to the duration of a sleep window of a second Type 2 power savings class of the Type 2 power savings class ranked pair, by starting the Type 2 power savings class having the shorter duration sleep window after the start of the Type 2 power savings class with the longer duration sleep window, at a time equal the difference between the respective durations of the first and second Type 2 power savings classes of the Type 2 power savings class ranked pair;
aligning the Type 2 power savings class ranked pair, in which the greatest common divisor of the Type 2 power savings class ranked pair does not equal one or in which the greatest common divisor does not equal the duration of the shorter Type 2 power savings class of the Type 2 power savings class ranked pair, and the duration of the sleep window of the first Type 2 power savings class is greater than the duration of the sleep window of the second Type 2 power savings class of the Type 2 power savings class ranked pair, by starting the Type 2 power savings class having the shorter duration sleep window after the start of the Type 2 power savings class with the longer duration sleep window, at a time equal to an absolute value of a difference between respective durations of the sleep windows of the first and second Type 2 power savings classes of the Type 2 power savings class ranked pair, but if a time equal to an absolute value of a difference between respective durations of the sleep windows of the first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at a time equal to the listening window of the second Type 2 power savings class of the Type 2 power savings class ranked pair;
aligning the Type 2 power savings class ranked pair, in which the greatest common divisor of the Type 2 power savings class ranked pair does not equal one or in which the greatest common divisor of the Type 2 power savings class ranked pair does not equal the duration of the shorter Type 2 power savings class, the duration of the sleep window of the second Type 2 power savings class is greater than the duration of the sleep window of the first Type 2 power savings class of the Type 2 power savings class ranked pair, and the duration of the listening window of the first Type 2 power savings class is greater than the duration of the listening window of the second Type 2 power savings class of the Type 2 power savings class ranked pair, by starting the Type 2 power savings class having the shorter duration after the start of the Type 2 power savings class with the longer duration sleep window, at a time equal to an absolute value of a difference between the respective durations of the sleep windows of the first and second Type 2 power savings classes of the Type 2 power savings class ranked pair, but if the time equal to the absolute value of the difference between respective durations of the sleep windows of the first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at a time equal to the listening window of the second Type 2 power savings class of the Type 2 power savings class ranked pair; and
aligning remaining Type 2 power savings class ranked pairs in which a greatest common divisor of the Type 2 power savings class ranked pair does not equal one or in which the greatest common divisor of the Type 2 power savings class ranked pair does not equal a duration of the shorter Type 2 power savings class by starting the Type 2 power savings class with the shorter duration after the start of the Type 2 power savings class with the longer duration sleep window, at a time equal to a difference between the respective durations of first and second Type 2 power savings classes of the Type 2 power savings class ranked pair, but if the time equal to the difference between respective durations of first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at the time equal to the listening window of the second Type 2 power savings class of the Type 2 power savings class ranked pair.

8. The method as in claim 1, wherein aligning the two or more aligned Type 1 power savings classes or, if only one Type 1 power savings class is selected, the selected Type 1 power savings class, and the two or more aligned Type 2 power savings classes or, if only one Type 2 power savings class is selected, the selected Type 2 power savings class, includes:
determining an aligned Type 1 power savings class which will be the last to start;
determining an aligned Type 2 power savings class with the shortest duration;
aligning the determined Type 1 power savings class with the determined Type 2 power savings class if a duration of a sleep window of the determined Type 2 power savings class is greater than a duration of an initial sleep window of the determined Type 1 power savings class and a duration of a listening window of the determined Type 2 power savings class is also greater than a duration of a listening window of the determined Type 1 power savings class, by starting the determined Type 1 power savings class at a time after the determined Type 2 power savings class equal to a difference between respective durations of the determined Type 2 power savings class sleep window and the determined Type 1 power savings class initial sleep window;
aligning the determined Type 1 power savings class with the determined Type 2 power savings class if the duration of the determined Type 1 power savings class initial sleep window is greater than the duration of the determined Type 2 power savings class sleep window and the duration of the determined Type 1 power savings class listening window is also greater than the duration of the determined Type 2 power savings class listening window, by starting the determined Type 2 power savings class at a time after the determined Type 1 power savings class equal to a difference between the respective durations of the determined Type 1 power savings class initial sleep window and the determined Type 2 power savings class sleep window;
aligning the determined Type 1 power savings class with the determined Type 2 power savings class if the duration of the determined Type 2 power savings class sleep window is greater than or equal to the duration of the determined Type 1 power savings class initial sleep window and the duration of the determined Type 1 power savings class listening window is also greater than or equal to the duration of the determined Type 2 power savings class listening window, by starting the determined Type 1 power savings class and the determined Type 2 power savings class at the same time;
aligning the determined Type 1 power savings class with the determined Type 2 power savings class if the duration of the determined Type 2 power savings class sleep window is equal to the duration of the determined Type 1 power savings class initial sleep window and the duration of the determined Type 2 power savings class listening window is greater than the duration of the determined Type 1 power savings class listening window, by starting the determined Type 1 power savings class at a time after the determined Type 2 power savings class equal to an absolute value of a difference between respective durations of the determined Type 2 power savings class and the determined Type 1 power savings class; and
aligning the determined Type 1 power savings class with the determined Type 2 power savings class if the duration of the determined Type 1 power savings class initial sleep window is greater than the duration of the determined Type 2 power savings class sleep window and the duration of the determined Type 2 power savings class listening window is greater than or equal to the duration of the determined Type 1 power savings class listening window, by starting a determined power savings class with the shorter duration at a time after a determined power savings class with the longer duration equal to the absolute value of the difference between the respective durations of the determined Type 2 power savings class and the determined Type 1 power savings class.

9. The method as in claim 1, wherein aligning the selected Type 3 power savings classes with the aligned Type 1 and Type 2 power savings classes includes matching a start time of the Type 3 power savings class with a start time of a last to start Type 1 power savings class or Type 2 power saving class.

10. The method as in claim 1, wherein the wireless communications network is compliant with IEEE 802.16e standard.

11. A wireless communication mobile station for wireless communication, the wireless communication mobile station comprising:
at least one memory to store data and instructions; and
at least one processor configured to access the memory and configured to, when executing the instructions:
select all Type 1 power savings classes, if present on a device;
select all Type 2 power savings classes, if present on the device;
select all Type 3 power savings classes, if present on the device;
align the selected Type 1 power savings classes of the device, if more than one Type 1 power savings class is selected;
align the selected Type 2 power savings classes of the device, if more than one Type 2 power savings class is selected;
align the two or more aligned Type 1 power savings classes or, if only one Type 1 power savings class is selected, the selected Type 1 power savings class, and the two or more aligned Type 2 power savings classes or, if only one Type 2 power savings class is selected, the selected Type 2 power savings class, if there is at least one selected Type 1 power savings class and at least one selected Type 2 power savings class; and
align the selected Type 3 power savings classes with the aligned Type 1 and Type 2 power savings classes, if there is at least one selected Type 3 power savings class and at least one Type 1 or Type 2 power savings class.

12. The wireless communication mobile station as in claim 11, wherein the at least one processor is further configured to execute instructions including communicating the alignment of any power savings classes to a base station.

13. The wireless communication mobile station as in claim 11, wherein:
each of the one or more Type 1 power savings classes has a series of equal fixed duration listening windows alternating with a series of sleep windows, and wherein each sleep window has twice a duration of a previous sleep window, up to a maximum sleep window duration, and an initial sleep window duration is greater than or equal to the listening window fixed duration;
each of the one or more Type 2 power savings classes has a series of equal fixed duration listening windows alternating with a series of equal fixed duration sleep windows and the sleep window duration is greater than the listening window duration; and
each of the one or more Type 3 power savings classes has a sleep window wherein durations and separations of an expected time period of activity and the sleep window is set based on an expected arrival of a next portion of data or next expected ranging request.

14. The wireless communication mobile station as in claim 11, wherein the at least one processor, when executing the instructions to align the selected Type 1 power savings classes of the device, is further configured to, when executing instructions:
sort the selected Type 1 power savings classes in order of increasing duration of initial sleep windows of the selected Type 1 power savings classes to define Type 1 power savings class ranked pairs;
align as a Type 1 power savings class twice length pair two Type 1 power savings classes for which the initial sleep window of a first Type 1 power savings class of the Type 1 power savings class twice length pair has twice a duration of the initial sleep window of a second Type 1 power savings class of the Type 1 power savings class twice length pair, the aligning including starting the second Type 1 power savings class at a time equal to the initial sleep window duration of the first Type 1 power savings class plus a duration of a listening window of the first Type 1 power savings class; and
align two Type 1 power savings classes in the Type 1 power savings class ranked pair, Type 1 power savings class ranked pair by Type 1 power savings class ranked pair, in the sorted order of increasing duration of the initial sleep windows of Type 1 power savings classes, except when the aligning of the Type 1 power savings class ranked pair changes an alignment of any Type 1 power savings class twice length pair.

15. The wireless communication mobile station as in claim 14, wherein the at least one processor, when executing the instructions to align two Type 1 power savings classes in the Type 1 power savings class ranked pair, Type 1 power savings class ranked pair by Type 1 power savings class ranked pair, in the sorted order of increasing duration of the initial sleep windows of Type 1 power savings classes, is further configured to, when executing instructions:
align the Type 1 power savings class ranked pair, for which a difference between an initial sleep window of a first Type 1 power savings class and an initial sleep window of a second Type 1 power savings class of the Type 1 power savings class ranked pair is an odd number of frames, by starting the Type 1 power savings class of the Type 1 power savings class ranked pair having a shorter duration initial sleep window after starting of the Type 1 power savings class of the Type 1 power savings class ranked pair having a longer duration initial sleep window, at a time equal to a difference between respective durations of the initial sleep windows of the Type 1 power savings class ranked pair; and
align the Type 1 power savings class ranked pair, for which the difference between the initial sleep window of the first Type 1 power savings class and the initial sleep window of the second Type 1 power savings class of the Type 1 power savings class ranked pair is an even number of frames, by starting both Type 1 power savings classes of the Type 1 power savings class ranked pair at the same time.

16. The wireless communication mobile station as in claim 11, wherein the at least one processor, when executing the instructions to align the selected Type 2 power savings classes of the device, is further configured to, when executing instructions:
sort the selected Type 2 power savings classes in order of decreasing respective durations of the selected Type 2 power savings classes into Type 2 power savings class ranked pairs;
determine a greatest common divisor for each Type 2 power savings class ranked pair, a greater duration Type 2 power savings class with its following Type 2 power savings class, in the sorted order of Type 2 power savings classes;
determine a difference between the respective durations for each Type 2 power savings class ranked pair, the greater duration Type 2 power savings class with its following Type 2 power savings class, in the sorted order of Type 2 power savings classes;
determine a number of rounds for each selected Type 2 power savings class to complete a cycle for each Type 2 power savings class ranked pair, the greater duration Type 2 power savings class with its following Type 2 power savings class, in the sorted order of Type 2 power savings classes;
determine a start time for each Type 2 power savings class ranked pair, the greater duration Type 2 power savings class with its following Type 2 power savings class, in the sorted order of Type 2 power savings classes; and
apply the determined start time for each Type 2 power savings class ranked pair.

17. The wireless communication mobile station as in claim 16, wherein the at least one processor, when executing the instruction to determines a start time for each Type 2 power savings class ranked pair, is further configured to, when executing instructions:
align a Type 2 power savings class ranked pair, in which the durations of the two Type 2 power savings classes are equal, by starting the two Type 2 power savings classes of the Type 2 power savings class ranked pair, at the same time;
align the Type 2 power savings class ranked pair, in which the greatest common divisor of the Type 2 power savings class ranked pair is equal to a Type 2 power savings class with the shorter duration of the Type 2 power savings class ranked pair, by starting the two Type 2 power savings classes of the Type 2 power savings class ranked pair, at the same time;
align the Type 2 power savings class ranked pair, in which the greatest common divisor of the Type 2 power savings class ranked pair is equal to one, a duration of a sleep window of a first Type 2 power savings class is greater than a duration of a sleep window of a second Type 2 power savings class of the Type 2 power savings class ranked pair, and the duration of the listening window of the second Type 2 power savings class is greater than a duration of the listening window of the first Type 2 power savings class of the Type 2 power savings class ranked pair, by starting the Type 2 power savings class having a shorter duration sleep window after the start of the Type 2 power savings class with a longer duration sleep window, at a time equal to a difference between respective durations of the sleep windows of the first and second Type 2 power savings classes of the Type 2 power savings class ranked pair;
align the Type 2 power savings class ranked pair, in which the greatest common divisor of the Type 2 power savings class ranked pair is equal to one, a duration of a sleep window of a first Type 2 power savings class is greater than a duration of a sleep window of a second Type 2 power savings class of the Type 2 power savings class ranked pair, and the duration of the listening window of the first Type 2 power savings class is greater than or equal to the duration of the listening window of the second Type 2 power savings class of the Type 2 power savings class ranked pair, by starting the Type 2 power savings class having the shorter duration sleep window after the start of the Type 2 power savings class with the longer duration sleep window, at a time equal to a difference between respective durations of the first and second Type 2 power savings classes of the Type 2 power savings class ranked pair;
align the Type 2 power savings class ranked pair, in which the greatest common divisor of the Type 2 power savings class ranked pair is equal to one and the duration of a sleep window of the first Type 2 power savings class is less than or equal to the duration of a sleep window of a second Type 2 power savings class of the Type 2 power savings class ranked pair, by starting the Type 2 power savings class having the shorter duration sleep window after the start of the Type 2 power savings class with the longer duration sleep window, at a time equal the difference between the respective durations of the first and second Type 2 power savings classes of the Type 2 power savings class ranked pair;
align the Type 2 power savings class ranked pair, in which the greatest common divisor of the Type 2 power savings class ranked pair does not equal one or in which the greatest common divisor does not equal the duration of the shorter Type 2 power savings class of the Type 2 power savings class ranked pair, and the duration of the sleep window of the first Type 2 power savings class is greater than the duration of the sleep window of the second Type 2 power savings class of the Type 2 power savings class ranked pair, by starting the Type 2 power savings class having the shorter duration sleep window after the start of the Type 2 power savings class with the longer duration sleep window, at a time equal to an absolute value of a difference between respective durations of the sleep windows of the first and second Type 2 power savings classes of the Type 2 power savings class ranked pair, but if the time equal to the absolute value of the difference between respective durations of the sleep windows of the first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at a time equal to the listening window of the second Type 2 power savings class of the Type 2 power savings class ranked pair;
align the Type 2 power savings class ranked pair, in which the greatest common divisor of the Type 2 power savings class ranked pair does not equal one or in which the greatest common divisor of the Type 2 power savings class ranked pair does not equal the duration of the shorter Type 2 power savings class, the duration of the sleep window of the second Type 2 power savings class is greater than the duration of the sleep window of the first Type 2 power savings class of the Type 2 power savings class ranked pair, and the duration of the listening window of the first Type 2 power savings class is greater than the duration of the listening window of the second Type 2 power savings class of the Type 2 power savings class ranked pair, by starting the Type 2 power savings class having the shorter duration after the start of the Type 2 power savings class with the longer duration sleep window, at a time equal to an absolute value of a difference between the respective durations of the sleep windows of the first and second Type 2 power savings classes of the Type 2 power savings class ranked pair, but if the time equal to the absolute value of the difference between respective durations of the sleep windows of the first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at a time equal to the listening window of the second Type 2 power savings class of the Type 2 power savings class ranked pair; and
align remaining Type 2 power savings class ranked pairs in which the greatest common divisor of the Type 2 power savings class ranked pair does not equal one or in which the greatest common divisor of the Type 2 power savings class ranked pair does not equal the duration of the shorter Type 2 power savings class by starting the Type 2 power savings class with the shorter duration after the start of the Type 2 power savings class with the longer duration sleep window, at a time equal to a difference between the respective durations of first and second Type 2 power savings classes of the Type 2 power savings class ranked pair, but if the time equal to the difference between respective durations of first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at the time equal to the listening window of the second Type 2 power savings class of the Type 2 power savings class ranked pair.

18. The wireless communication mobile station as in claim 11, wherein the at least one processor, when executing the instruction to align the two or more aligned Type 1 power savings classes or, if only one Type 1 power savings class is selected, the selected Type 1 power savings class, and the two or more aligned Type 2 power savings classes or, if only one Type 2 power savings class is selected, the selected Type 2 power savings class, is further configured to, when executing instructions:
determine an aligned Type 1 power savings class which will be the last to start;
determine an aligned Type 2 power savings class with the shortest duration;
align the determined Type 1 power savings class with the determined Type 2 power savings class if a duration of a sleep window of the determined Type 2 power savings class is greater than a duration of an initial sleep window of the determined Type 1 power savings class and a duration of a listening window of the determined Type 2 power savings class is also greater than a duration of a listening window of the determined Type 1 power savings class, by starting the determined Type 1 power savings class at a time after the determined Type 2 power savings class equal to a difference between respective durations of the determined Type 2 power savings class sleep window and the determined Type 1 power savings class initial sleep window;
align the determined Type 1 power savings class with the determined Type 2 power savings class if the duration of the determined Type 1 power savings class initial sleep window is greater than the duration of the determined Type 2 power savings class sleep window and the duration of the determined Type 1 power savings class listening window is also greater than the duration of the determined Type 2 power savings class listening window, by starting the determined Type 2 power savings class at a time after the determined Type 1 power savings class equal to a difference between the respective durations of the determined Type 1 power savings class initial sleep window and the determined Type 2 power savings class sleep window;
align the determined Type 1 power savings class with the determined Type 2 power savings class if the duration of the determined Type 2 power savings class sleep window is greater than or equal to the duration of the determined Type 1 power savings class initial sleep window and the duration of the determined Type 1 power savings class listening window is also greater than or equal to the duration of the determined Type 2 power savings class listening window, by starting the determined Type 1 power savings class and the determined Type 2 power savings class at the same time;
align the determined Type 1 power savings class with the determined Type 2 power savings class if the duration of the determined Type 2 power savings class sleep window is equal to the duration of the determined Type 1 power savings class initial sleep window and the duration of the determined Type 2 power savings class listening window is greater than the duration of the determined Type 1 power savings class listening window, by starting the determined Type 1 power savings class at a time after the determined Type 2 power savings class equal to an absolute value of a difference between respective durations of the determined Type 2 power savings class and the determined Type 1 power savings class; and
align the determined Type 1 power savings class with the determined Type 2 power savings class if the duration of the determined Type 1 power savings class initial sleep window is greater than the duration of the determined Type 2 power savings class sleep window and the duration of the determined Type 2 power savings class listening window is greater than or equal to the duration of the determined Type 1 power savings class listening window, by starting a determined power savings class with the shorter duration at a time after a determined power savings class with the longer duration equal to the absolute value of the difference between the respective durations of the determined Type 2 power savings class and the determined Type 1 power savings class.

19. The wireless communication mobile station as in claim 11, wherein aligning the selected Type 3 power savings classes with the aligned Type 1 and Type 2 power savings classes includes matching the start time of the Type 3 power savings class with the start time of a last to start Type 1 power savings class or Type 2 power savings class.

20. The wireless communication mobile station as in claim 11, wherein the wireless communications network is compliant with IEEE 802.16e standard.

21. A computer-readable medium including instructions for performing a method, when executed by a processor, for power savings in a wireless communications network, the method comprising:
selecting all Type 1 power savings classes, if present on a device, wherein each of the one or more Type 1 power savings classes has a series of equal fixed duration listening windows alternating with a series of sleep windows, and wherein each sleep window has twice a duration of a previous sleep window, up to a maximum sleep window duration, and an initial sleep window duration is greater than or equal to the listening window fixed duration;
selecting all Type 2 power savings classes, if present on the device, wherein each of the one or more Type 2 power savings classes has a series of equal fixed duration listening windows alternating with a series of equal fixed duration sleep windows and the sleep window duration is greater than the listening window duration;
selecting all Type 3 power savings classes, if present on the device, wherein each of the one or more Type 3 power savings classes has a sleep window wherein durations and separations of an expected time period of activity and the sleep window is set based on an expected arrival of a next portion of data or next expected ranging request;
aligning the selected Type 1 power savings classes of the device, if more than one Type 1 power savings class is selected;
aligning the selected Type 2 power savings classes of the device, if more than one Type 2 power savings class is selected;
aligning the two or more aligned Type 1 power savings classes or, if only one Type 1 power savings class is selected, the selected Type 1 power savings class, and the two or more aligned Type 2 power savings classes or, if only one Type 2 power savings class is selected, the selected Type 2 power savings class, if there is at least one selected Type 1 power savings class and at least one selected Type 2 power savings class;
aligning the selected Type 3 power savings classes with the aligned Type 1 and Type 2 power savings classes, if there is at least one selected Type 3 power savings class and at least one Type 1 or Type 2 power savings class; and
communicating the alignment of any Type 1, Type 2, or Type 3 power savings classes to a base station.

22. The computer-readable medium as in claim 21, wherein the aligning of the selected Type 1 power savings classes further includes:
sorting the selected Type 1 power savings classes in order of increasing duration of initial sleep windows of the selected Type 1 power savings classes to define Type 1 power savings class ranked pairs;
aligning as a Type 1 power savings class twice length pair two Type 1 power savings classes for which the initial sleep window of a first Type 1 power savings class of the Type 1 power savings class twice length pair has twice a duration of the initial sleep window of a second Type 1 power savings class of the Type 1 power savings class twice length pair, the aligning including starting the second Type 1 power savings class at a time equal to the initial sleep window duration of the first Type 1 power savings class plus a duration of a listening window of the first Type 1 power savings class;
aligning two Type 1 power savings classes in the Type 1 power savings class ranked pair, Type 1 power savings class ranked pair by Type 1 power savings class ranked pair, in the sorted order of increasing duration of the initial sleep windows of Type 1 power savings classes, except when the aligning of the Type 1 power savings class ranked pair changes an alignment of any Type 1 power savings class twice length pair, wherein aligning two Type 1 power savings classes in a Type 1 power savings class ranked pair, Type 1 power savings class ranked pair by Type 1 power savings class ranked pair, in the sorted order of Type 1 power savings classes, further includes:
aligning the Type 1 power savings class ranked pair, for which a difference between an initial sleep window of a first Type 1 power savings class and an initial sleep window of a second Type 1 power savings class of the Type 1 power savings class ranked pair is an odd number of frames, by starting the Type 1 power savings class of the Type 1 power savings class ranked pair having a shorter duration initial sleep window after starting of the Type 1 power savings class of the Type 1 power savings class ranked pair having a longer duration initial sleep window, at a time equal to a difference between respective durations of the initial sleep windows of the Type 1 power savings class ranked pair; and
aligning the Type 1 power savings class ranked pair, for which the difference between the initial sleep window of the first Type 1 power savings class and the initial sleep window of the second Type 1 power savings class of the Type 1 power savings class ranked pair is an even number of frames, by starting both Type 1 power savings classes of the Type 1 power savings class ranked pair at the same time.

23. The computer-readable medium as in claim 21, wherein the aligning of the selected Type 2 power savings classes further includes:
sorting the selected Type 2 power savings classes in order of decreasing respective durations of the selected Type 2 power savings classes into Type 2 power savings class ranked pairs;
determining a greatest common divisor for each Type 2 power savings class ranked pair, a greater duration Type 2 power savings class with its following Type 2 power savings class, in the sorted order of Type 2 power savings classes;
determining a difference between the respective durations for each Type 2 power savings class ranked pair, the greater duration Type 2 power savings class with its following Type 2 power savings class, in the sorted order of Type 2 power savings classes;
determining a number of rounds for each selected Type 2 power savings class to complete a cycle for each Type 2 power savings class ranked pair, the greater duration Type 2 power savings class with its following Type 2 power savings class, in the sorted order of Type 2 power savings classes;
determining a start time for each Type 2 power savings class ranked pair, the greater duration Type 2 power savings class with its following Type 2 power savings class, in the sorted order of Type 2 power savings classes, wherein determining a start time for each Type 2 power savings class ranked pair further includes:
aligning a Type 2 power savings class ranked pair, in which the durations of the two Type 2 power savings classes are equal, by starting the two Type 2 power savings classes of the Type 2 power savings class ranked pair, at the same time;
aligning the Type 2 power savings class ranked pair, in which the greatest common divisor of the Type 2 power savings class ranked pair is equal to a Type 2 power savings class with the shorter duration of the Type 2 power savings class ranked pair, by starting the two Type 2 power savings classes of the Type 2 power savings class ranked pair, at the same time;
aligning the Type 2 power savings class ranked pair, in which the greatest common divisor of the Type 2 power savings class ranked pair is equal to one, a duration of a sleep window of a first Type 2 power savings class is greater than a duration of a sleep window of a second Type 2 power savings class of the Type 2 power savings class ranked pair, and the duration of the listening window of the second Type 2 power savings class is greater than a duration of the listening window of the first Type 2 power savings class of the Type 2 power savings class ranked pair, by starting the Type 2 power savings class having a shorter duration sleep window after the start of a Type 2 power savings class with a longer duration sleep window, at a time equal to a difference between respective durations of the sleep windows of the first and second Type 2 power savings classes of the Type 2 power savings class ranked pair;
aligning the Type 2 power savings class ranked pair, in which the greatest common divisor of the Type 2 power savings class ranked pair is equal to one, a duration of a sleep window of a first Type 2 power savings class is greater than a duration of a sleep window of a second Type 2 power savings class of the Type 2 power savings class ranked pair, and the duration of the listening window of the first Type 2 power savings class is greater than or equal to the duration of the listening window of the second Type 2 power savings class of the Type 2 power savings class ranked pair, by starting the Type 2 power savings class having the shorter duration sleep window after the start of the Type 2 power savings class with the longer duration sleep window, at a time equal to a difference between respective durations of the first and second Type 2 power savings classes of the Type 2 power savings class ranked pair;
aligning the Type 2 power savings class ranked pair, in which the greatest common divisor of the Type 2 power savings class ranked pair is equal to one and the duration of a sleep window of the first Type 2 power savings class is less than or equal to the duration of a sleep window of a second Type 2 power savings class of the Type 2 power savings class ranked pair, by starting the Type 2 power savings class having the shorter duration sleep window after the start of the Type 2 power savings class with the longer duration sleep window, at a time equal the difference between the respective durations of the first and second Type 2 power savings classes of the Type 2 power savings class ranked pair;
aligning the Type 2 power savings class ranked pair, in which the greatest common divisor of the Type 2 power savings class ranked pair does not equal one or in which the greatest common divisor does not equal the duration of the shorter Type 2 power savings class of the Type 2 power savings class ranked pair, and the duration of the sleep window of the first Type 2 power savings class is greater than the duration of the sleep window of the second Type 2 power savings class of the Type 2 power savings class ranked pair, by starting the Type 2 power savings class having the shorter duration sleep window after the start of the Type 2 power savings class with the longer duration sleep window, at a time equal to an absolute value of a difference between respective durations of the sleep windows of the first and second Type 2 power savings classes of the Type 2 power savings class ranked pair, but if the time equal to the absolute value of the difference between respective durations of the sleep windows of the first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at a time equal to the listening window of the second Type 2 power savings class of the Type 2 power savings class ranked pair;
aligning the Type 2 power savings class ranked pair, in which the greatest common divisor of the Type 2 power savings class ranked pair does not equal one or in which the greatest common divisor of the Type 2 power savings class ranked pair does not equal the duration of the shorter Type 2 power savings class, the duration of the sleep window of the second Type 2 power savings class is greater than the duration of the sleep window of the first Type 2 power savings class of the Type 2 power savings class ranked pair, and the duration of the listening window of the first Type 2 power savings class is greater than the duration of the listening window of the second Type 2 power savings class of the Type 2 power savings class ranked pair, by starting the Type 2 power savings class having the shorter duration after the start of the Type 2 power savings class with the longer duration sleep window, at a time equal to an absolute value of a difference between respective durations of the sleep windows of the first and second Type 2 power savings classes of the Type 2 power savings class ranked pair, but if the time equal to the absolute value of the difference between the respective durations of the sleep windows of the first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at a time equal to the listening window of the second Type 2 power savings class of the Type 2 power savings class ranked pair; and
aligning remaining Type 2 power savings class ranked pairs in which the greatest common divisor of the Type 2 power savings class ranked pair does not equal one or in which the greatest common divisor of the Type 2 power savings class ranked pair does not equal the duration of the shorter Type 2 power savings class by starting the Type 2 power savings class with the shorter duration after the start of the Type 2 power savings class with the longer duration sleep window, at a time equal to a difference between the respective durations of first and second Type 2 power savings classes of the Type 2 power savings class ranked pair, but if the time equal to the difference between respective durations of first and second Type 2 power savings classes of the Type 2 power savings class ranked pair is greater than a listening window of the second Type 2 power savings class of the Type 2 power savings class ranked pair, starting the Type 2 power savings class having the shorter duration sleep window after the start of the Type 2 power savings class with the longer duration sleep window, at the time equal to the listening window of the second Type 2 power savings class of the Type 2 power savings class ranked pair; and
applying the determined start time for each Type 2 power savings class ranked pair

24. The computer-readable medium as in claim 21, wherein the aligning of the two or more aligned Type 1 power savings classes or, if only one Type 1 power savings class is selected, the selected Type 1 power savings class, and the two or more aligned Type 2 power savings classes or, if only one Type 2 power savings class is selected, the selected Type 2 power savings class, includes:
determining an aligned Type 1 power savings class which will be the last to start;
determining an aligned Type 2 power savings class with the shortest duration;
aligning the determined Type 1 power savings class with the determined Type 2 power savings class if a duration of a sleep window of the determined Type 2 power savings class is greater than a duration of an initial sleep window of the determined Type 1 power savings class and a duration of a listening window of the determined Type 2 power savings class is also greater than a duration of a listening window of the determined Type 1 power savings class, by starting the determined Type 1 power savings class at a time after the determined Type 2 power savings class equal to a difference between respective durations of the determined Type 2 power savings class sleep window and the determined Type 1 power savings class initial sleep window;
aligning the determined Type 1 power savings class with the determined Type 2 power savings class if the duration of the determined Type 1 power savings class initial sleep window is greater than the duration of the determined Type 2 power savings class sleep window and the duration of the determined Type 1 power savings class listening window is also greater than the duration of the determined Type 2 power savings class listening window, by starting the determined Type 2 power savings class at a time after the determined Type 1 power savings class equal to a difference between the respective durations of the determined Type 1 power savings class initial sleep window and the determined Type 2 power savings class sleep window;
aligning the determined Type 1 power savings class with the determined Type 2 power savings class if the duration of the determined Type 2 power savings class sleep window is greater than or equal to the duration of the determined Type 1 power savings class initial sleep window and the duration of the determined Type 1 power savings class listening window is also greater than or equal to the duration of the determined Type 2 power savings class listening window, by starting the determined Type 1 power savings class and the determined Type 2 power savings class at the same time;
aligning the determined Type 1 power savings class with the determined Type 2 power savings class if the duration of the determined Type 2 power savings class sleep window is equal to the duration of the determined Type 1 power savings class initial sleep window and the duration of the determined Type 2 power savings class listening window is greater than the duration of the determined Type 1 power savings class listening window, by starting the determined Type 1 power savings class at a time after the determined Type 2 power savings class equal to an absolute value of a difference between respective durations of the determined Type 2 power savings class and the determined Type 1 power savings class; and
aligning the determined Type 1 power savings class with the determined Type 2 power savings class if the duration of the determined Type 1 power savings class initial sleep window is greater than the duration of the determined Type 2 power savings class sleep window and the duration of the determined Type 2 power savings class listening window is greater than or equal to the duration of the determined Type 1 power savings class listening window, by starting a determined power savings class with the shorter duration at a time after a determined power savings class with the longer duration equal to the absolute value of the difference between the respective durations of the determined Type 2 power savings class and the determined Type 1 power savings class.

25. The computer-readable medium as in claim 21, wherein the aligning of the selected Type 3 power savings classes with the aligned Type 1 and Type 2 power savings classes includes matching the start time of the Type 3 power savings class with the start time of a last to start Type 1 power savings class or Type 2 power savings class.
